(19) United States
(12) Patent Application Publication
(10) Pub. No.: US 2016/0358265 A1
(43) Pub. Date: Dec. 8, 2016

(54) Methods and Systems for Determining a Deduction Rate from a Starting Value

(71) Applicant: Compass Point Retirement Planning, Inc., Wakefield, MA (US)

(72) Inventor: Michael James LaBrie, Marblehead, MA (US)

(21) Appl. No.: 15/239,112

(22) Filed: Aug. 17, 2016

Related U.S. Application Data
(62) Division of application No. 13/799,410, filed on Mar. 13, 2013, now abandoned.
(60) Provisional application No. 61/664,245, filed on Jun. 26, 2012.

(51) Int. Cl. G06Q 40/06

(52) U.S. Cl. CPC G06Q 40/06

(57) ABSTRACT

A method and system for determining a deduction rate from a starting value, which maximizes the deduction rate without reducing the starting value to zero over a given time period. In an embodiment, a method may include using a computer processor to test deduction rates against historical data of previous changes in value of the starting value and determine a target deduction rate that achieves a desired percentage of historically successful outcomes for the starting value, determining a value gap difference between the starting value and an estimated internal value based on historical data, and adjusting the target deduction rate by the value gap difference to determine the deduction rate. The deduction rate may comprise a largest periodic amount that can be deducted from the starting value without reducing the starting value to zero over the given time period.

This application is a division of U.S. Published Patent Application No. US2014/0101073, published Apr. 10, 2014 (U.S. patent application Ser. No. 13/799,410, filed Mar. 13, 2013), which claims the benefit of U.S. Provisional Application No. 61/664,245, filed Jun. 26, 2012, both of which are herein incorporated by reference in their entirety.

### BACKGROUND

Field of the Invention

The present embodiments relate generally to investment account management and, more particularly, to systems and methods for managing income distribution from investment accounts and for determining a safe income withdrawal rate from an investment account.

Background of the Invention

Financial services providers, such as Independent Registered Investment Advisor firms (RIAs), through their agents, Investment Advisor Representatives or Registered Representatives, handle custody, management, and income distribution from retirement investment accounts such as 401(k) plans, IRA accounts, pension plan assets, and other taxable accounts. These are all sources for creating retirement income for investors who do not want to see their retirement paychecks from these assets run out. A client of an RIA typically rolls over or transfers 401(k) balances, pension lump sum amounts, IRA accounts, and other non-retirement plan assets to accounts that the RIA manages, structuring income strategies intended to last for the client's lifetime.

For investors approaching or already enjoying retirement, an important question regarding the income derived from these retirement investment accounts is: “What is the MOST I can take SAFELY.” More specifically, investors must determine with as much precision as possible the largest inflation-adjusted steady monthly “paycheck” amount that can be withdrawn from their “nest egg” investments without those accounts running out during their lives or eventually being forced to reduce their effective income. It may turn out to be that the investor does not want to take the maximum amount, but the investor still must know how much that maximum is to know the investor is not exceeding it.

This maximum amount is often referred to in the financial services industry as the “safe maximum withdrawal rate” or “safe draw rate.” It is typically expressed in percentage terms regarding the total annual amount. In this term of art, the word “safe” refers to looking backward using historical data to determine what would have been the “safe” withdrawal rate through varying investment performance periods that resulted in no instances of the portfolio depleting in any prior targeted period, e.g., various periods of some 30 consecutive years or other relevant time frame. It is not intended to imply certainty of success in the future, although the intention is to create the highest likelihood possible of achieving that result. However, the financial services industry has to date not been able to determine the safe maximum withdrawal rate with high enough precision. As a result, with current methods retirement income investors face a significant possibility of either running out of money too soon due to taking too much income, or conversely, not taking as much as they could have and thus shortchange the quality of life they might have enjoyed.

Thus, there remains a need for methods and systems that manage income distributions from investment accounts and more accurately determine safe maximum withdrawal rates.

### SUMMARY

Embodiments provide a system and method for more precisely determining a safe income withdrawal rate from an investment account and for managing income distributions. The determination may be based on an internal portfolio valuation model, for example, created by a mathematical regression of market data or by some other means for calculating initial and subsequent withdrawal amounts. In further embodiments, a calculation of a withdrawal amount may be repeated periodically to determine whether to increase, or “step-up,” withdrawal amounts going forward whenever possible and if desired. If utilized, the step-up in income may be a permanent increase going forward.

Embodiments use methods and systems that base withdrawal rates on a more stable historically calculated “internal portfolio valuation,” instead of the erratically fluctuating and undisciplined portfolio price that has been typically used in the prior art. As a result, the reliability of the safe maximum withdrawal rate calculation may be increased by more than an order of magnitude over conventional approaches. The resulting benefit may potentially save tens of millions of people from either financial ruin or from not enjoying the lifestyle they could have enjoyed. The efficacy, reliability, and benefits of embodiments of this value-adjusted income planning may be proven by applying the methods and systems to more than 200 years of well-accepted historical market data. For example, embodiments may be tested using rolling 30-year withdrawal periods starting from 1801 to 1982 (since market data ends at the present time, around 2012).

In one aspect, an embodiment provides a method for determining a safe maximum withdrawal rate from an investment account, including determining, using a computer processor, a target draw rate that achieves a desired percentage of historically successful outcomes for the investment account, and then adjusting the target draw rate by a value gap to determine the safe maximum withdrawal rate. Determining the target draw rate that achieves a desired percentage of historically successful outcomes for the investment account may be based relative to a calculated internal value. The value gap may be a differential function.

In another aspect, an embodiment provides a method for managing distributions associated with an investment account. The method may include determining a subset of securities of a broad market that has historically outperformed the broad market, wherein the subset of securities historically provided a higher return than a lower return of the broad market; determining a target draw rate; determining, using a computer processor, a value gap, wherein the value gap is the difference between a current value (e.g., current market price valuation) of the subset of securities and an estimated internal value of the subset of securities; adjusting, using a computer processor, the target draw rate by the value gap to determine a historically safe maximum withdrawal rate; investing funds of the investment account in the subset of securities; distributing income to an owner of the investment account according to the safe maximum withdrawal rate; and using a difference between the higher return and the lower return to pay fees associated with the investment account. Fees associated with the investment account may be based on the estimated internal value as opposed to the current value, or market price, of the investment account.

In another aspect, an embodiment provides a method for managing distributions associated with an investment account. The method may include determining a target draw rate; adjusting, using a computer processor, the target draw rate by a value gap to determine a safe maximum withdrawal rate, wherein the value gap is determined based on data of a broad market; investing funds of the investment account in a subset of securities of the broad market that has historically outperformed the broad market, wherein the subset of securities provides a higher return than a lower return of the broad market; distributing income to an owner of the investment account according to the safe maximum withdrawal rate; and using a difference between the higher return and the lower return to pay fees associated with the investment account.

In another aspect, an embodiment provides a system for determining a safe maximum withdrawal rate from an investment account. The system may include a market data computer processor and a withdrawal rate computer processor. The market data computer processor may calculate a total return and an internal value associated with the investment account. The withdrawal rate computer processor may determine a target draw rate that achieves a desired percentage of historically successful outcomes for the investment account, determine a value gap based on the total return and the internal value, and adjust the target draw rate by the value gap to determine the safe maximum withdrawal rate.

Other systems, methods, features, and advantages of the embodiments will be, or will become, apparent to one of ordinary skill in the art upon examination of the following figures and detailed description. It is intended that all such additional systems, methods, features, and advantages be included within this description and this summary, be within the scope of the embodiments, and be protected by the claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1A is a graph that illustrates an analysis of over 200 years of U.S. stock market performance, including real total return, an internal value regression analysis, and a value gap analysis, according to a present embodiment.

FIG. 1B is a graph that illustrates an embodiment of a value gap index.

FIG. 2A is a flow chart that illustrates an embodiment of a method for determining a safe income withdrawal rate from an investment account.

FIG. 2B is a schematic diagram that illustrates an embodiment of a system 200 for determining a safe maximum withdrawal rate.

FIG. 3 is a graph showing the erratic outcome of a traditional approach that uses only the starting portfolio price to set the first of 30-years-worth of steady inflation-adjusted withdrawals.

FIGS. 4-9 are graphs illustrating a distribution of outcomes for a static inflation adjusted withdrawal rate strategy using a gross starting portfolio amount of $100,000 and monthly withdrawals starting at a 5% annual rate adjusted for inflation for each scenario using an exemplary balanced portfolio (60% U.S. stock/40% U.S. Bond), rebalanced constantly.

FIG. 10 is a graph that illustrates the results of applying a value gap adjustment to the first paycheck from each data series in the example of FIG. 3, according to an embodiment.

FIG. 11A is a graph that illustrates the data of FIG. 10 zoomed in on the y-axis and scaled from −$100,000 to $500,000.

FIG. 11B is a graph that illustrates selected starting dates of the data of FIG. 10 zoomed in on the y-axis and scaled from $0 to $200,000.

FIG. 12 is a graph that illustrates the account values of two exemplary portfolios, comparing the results of traditional withdrawal rates to the results of present embodiments of withdrawal rates applying a value gap adjustment.

FIGS. 13-15 are graphs illustrating another embodiment of a system and method for determining a safe income withdrawal rate from an investment account.

FIG. 16 is a table listing target historically safe maximum withdrawal rates for a Fama-French Value Blend fund according to an embodiment.

FIG. 17 is a table listing target historically safe maximum withdrawal rates for a Fama-French Value Blend fund and for different goals and risk tolerances, according to an embodiment.

FIG. 18 is a table of historical values used to construct a target safe maximum withdrawal database, according to an embodiment.

FIG. 19 is an image of an exemplary graphical user interface for receiving user designated parameters of a safe withdrawal amount calculation, and for displaying results of the calculation, according to an embodiment.

FIG. 20 is an image of an exemplary graphical user interface showing user input and program output for a test of a value gap method at a user-designated 5.4% withdrawal rate, resulting in downside failures, according to an embodiment.

FIG. 21 is an image of an exemplary graphical user interface showing user input and program output for a test of a value gap method at a user-designated withdrawal rate of 5.3% (lower in comparison to FIG. 20), resulting no downside failures, according to an embodiment.

FIG. 22 is an exemplary fund value database table for tracking historical values associated with a fund, according to an embodiment.

FIG. 23 is an image of an exemplary graphical user interface for receiving user input of data associated with a fund, according to an embodiment.

FIG. 24 is an exemplary fund value summary table, according to an embodiment.

FIG. 25 is an image of an exemplary graphical user interface for receiving, from a user, parameters for a safe withdrawal amount computation, according to an embodiment.

FIG. 26 is an image of an exemplary graphical user interface for displaying results of a safe withdrawal amount computation, according to an embodiment.

FIG. 27 is an image of an exemplary graphical user interface for displaying results in addition to those of FIG. 26, including target safe withdrawal rates and value gap factors for other time horizons, according to an embodiment.

FIG. 28 is an exemplary linear chart associated with the results of FIG. 26, showing the relationship between the current total return line and the trend line, according to an embodiment.

FIGS. 29-31 are images of an exemplary graphical user interface for receiving user input and displaying results of another safe withdrawal amount computation, according to an embodiment.

FIG. 32 is a flow chart that illustrates another embodiment of a method for determining a safe income withdrawal rate from an investment account.

### DETAILED DESCRIPTION

Embodiments provide methods and systems for determining a safe income withdrawal rate from an investment account and for managing income distributions.

The question of a safe maximum withdrawal rate has been unsettled science. A Jan. 22, 2012 article in Investment News (Mercado, Darla, 4% Withdrawal Rate Called Into Question, Jan. 22, 2012) shows the uncertainty. A March 2013 article in the Wall Street Journal (Greene, Kelly; Say Goodbye to the 4% Rule, Mar. 1, 2013) reaffirms this uncertainty. Twenty years ago, the “common wisdom” to many financial advisors seemed to be that 7% gross annual distribution rate from a balanced stock and bond portfolio would provide an acceptable level of historic reliability. Then, as more experience was gained with withdrawal outcomes and as the effects of market volatility became better understood, it fell to 6%, then 5%, more recently 4%, and according to these articles, now maybe 4% is too much.

The challenge is the uncertainty around future volatility. The problem is mostly manifested in what is often called “sequence of returns” risk. Sequence of returns risk is evident when otherwise identical investors experience wildly different results even though their portfolios generated the same average investment rate of return during their retirement career. The difference comes from when and in what sequence the up and down cycles in their investments happened.

This is a conundrum that the industry has yet to solve with sufficient precision, although many within the industry have been trying for a many years. The attempts are fundamentally focused around trying to negate volatility by various forms of investment management. There is a massive industry that has been built around doing this. In contrast, the present embodiments may provide a more efficient way to determine safe draw rates, which does not rely on complex investment management and is profoundly more reliable. The present embodiments have also been successfully back tested over more than 200 years of historical U.S. equity market data.

Within stock markets, price and value of individual companies and entire markets are not typically in line with one another. Instead, the price typically fluctuates around a more stable value—external forces push prices up and down, yet these prices have historically trended back to a steadily rising mean value level over time in what is often referred to as “reversion to the mean.” There has never been universal agreement on a practical way to define this “internal value.” Typically, all financial professionals had to work from was the fluctuating price. Basing rates of withdrawals on just the current portfolio price without accounting for the underlying variance in valuation made results very unreliable, hence the confusion over determining a safe maximum withdrawal rate.

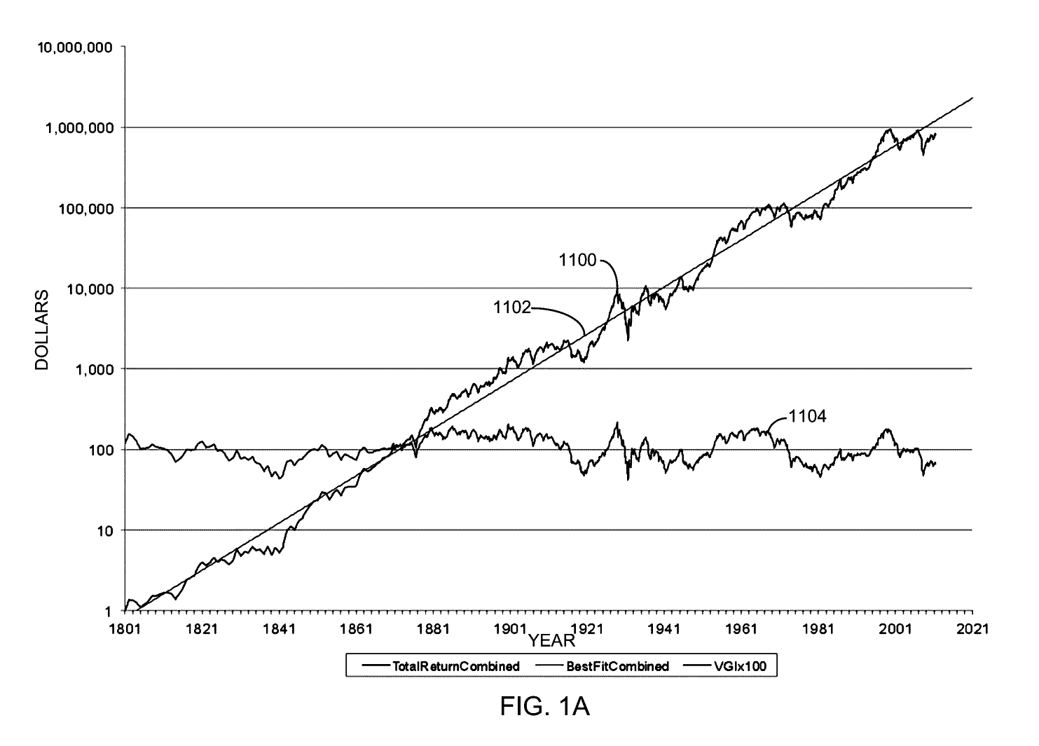

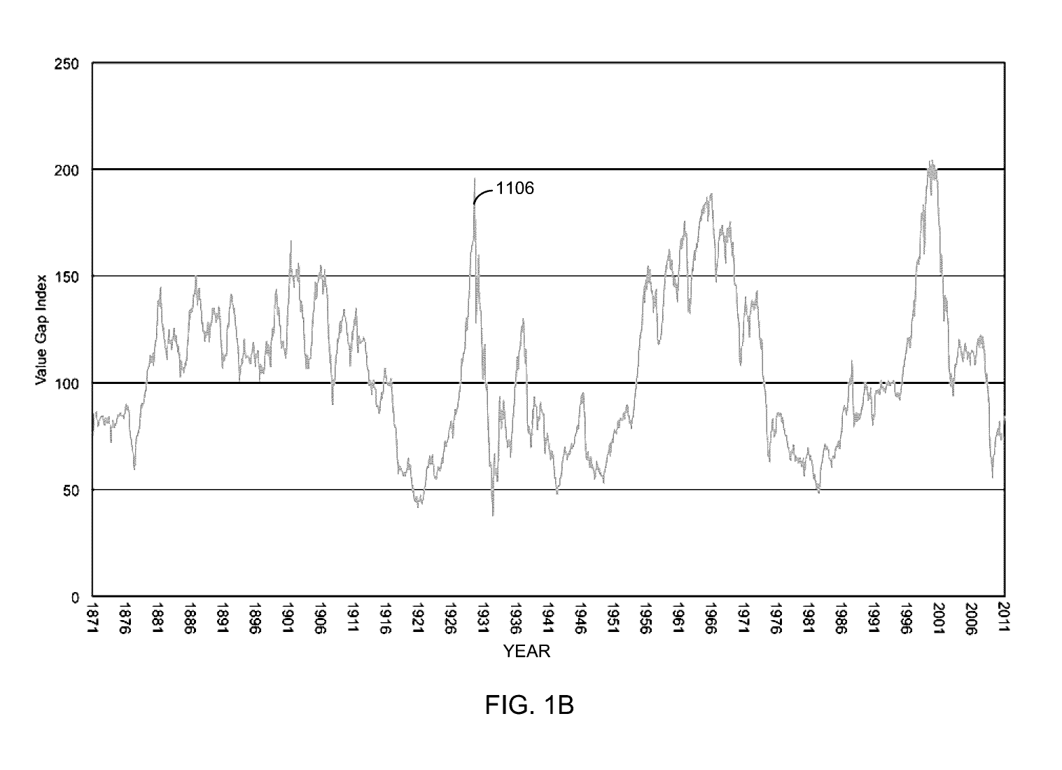

FIG. 1A is a graph that illustrates over 200 years of U.S. stock market performance, shown as the growth of a theoretical dollar invested in 1801, represented by the total return line 1100. Total return line 1100 is shown on a logarithmic scale and graphed as real total return, i.e., with dividends reinvested and inflation taken out to show only true performance. This is index data with no real world costs such as taxes or transaction costs. The source of this data is monthly data from Dr. Robert Shiller of Yale University dating back to January 1871, and annual data from Dr. Jeremy Siegel of the Wharton School prior to 1871. These sources also provide the Consumer Price Index (CPI) data for inflation.

The straight trend line 1102 on the graph is a logarithmic regression line and is calculated as the mathematical “best fit” of the data shown by the total return line 1100. As seen, the trend line 1102 demonstrates a consistent 200-year market trend, with the price reverting to a trend represented by line 1102. On a logarithmic graph, the slope of a best fit straight line, determined in this case by logarithmic regression, correlates or approximates the average rate of return for the period. The best fit has two components: slope and y-intercept. If y-intercept is higher than the starting value, then slope is slightly flatter than the rate of return. In FIG. 1A, the slope of line 1102 is roughly 6.7% (which the inventor refers to as the “speed of capitalism”). If inflation were to be factored back in, the average increase approaches 10% per year, which is often said to be the long-term performance average of the broad U.S. stock market.

The trend line 1102 provides a very good estimate of the “internal value” described above, and is sufficient enough to give what is needed to solve the withdrawal rate problem. For purposes of the present embodiments, examples of acceptable regression analyses may be found in Jeremy Siegel's book Stocks for the Long Run, which includes exemplary regression analysis charts, and is herein incorporated by reference. What is profound here is that through all of this history—regardless of world wars, deep recessions, the Great Depression, multi-decade economic downturns, the highest and lowest periods of inflation, unemployment and interest rates, presidential assassinations, epic natural and man-made disasters, even technological revolution (agricultural economy to industrial economy to information economy), etc., the performance of the U.S. equity markets keeps tracking to the specific trend approximated by line 1102 shown in the graph of FIG. 1A.

Finding internal value in the historical prices of any equity commodity such as stocks or real estate is not unlike how scientists search the universe for phenomena such as black holes. The scientists cannot see the black hole itself; they find it instead by observing effects on objects around it. Likewise, to determine internal value of an investment portfolio, one may approximate it by looking for the effect it has on the normalized real total return price data that can be measured with precision by some manner of regressing the data to find the “middle of noise.” This may be thought of as analogous to a weak gravitational force between the price and value. As price gets pushed away from value by temporarily stronger forces, the force doing the pushing (fear, greed, etc.) eventually weakens, while the weaker but constant gravity-like pull between price and value relentlessly pulls the price back towards its internal value. A better analogy may be that of a spring that exerts a weak force when in its natural state, but provides more influence the further its end points are stretched apart.

What occurs over time is that when prices are pushed to levels much higher than the internal value (e.g., the total return line 1100 goes well above the trend line 1102), the portfolio appears to be worth much more in the eyes of investors than its internal value would indicate. Indeed, until now the investors most likely were not aware of such an invisible concept. An example of this situation occurred with 401(k) portfolios through the year 2000. Many investors felt much wealthier than it turned out they really were. Going forward from periods of excessively high valuation like the tech-stock bubble, the inflated price over time reverts towards its true internal value and as a result the average annual rate of investment return during that following retirement-length period will be lower (or even negative) while it trends back in line in seemingly random volatile fashion continuing to be influenced by other weaker external driving forces along the way. The opposite is true as well. When prices are exceptionally low relative to internal value, the portfolio has historically earned more than typical going forward to catch back up. In this sense, although volatility never stops, the volatility cancels itself out over time—and price reverts to its mean.

With this reversion-to-the-mean concept in mind, the present embodiments address a fundamental flaw with the current methods used for determining “safe maximum withdrawal rate,” namely, that the current methods base the safe draw rate assumption only on the erratic and unpredictable portfolio price without accounting for the internal value—because price has always been the only basis from which to work.

An analysis of the historical U.S. equity market data demonstrates that there is a level of draw rate that would have worked successfully over a typical 30-year time frame for any time the price started at or near the internal value, i.e., when the total return line 1100 and the trend line 1102 on the graph of FIG. 1A are at the same level. In the present embodiments, that draw rate is slightly above 5.3% for a broad portfolio of large U.S. stocks, but for simplicity sake assume it to be 5% of the starting portfolio value adjusted for inflation going forward. If that same 5% rate of draw were applied to any significantly overpriced portfolio (e.g., when the total return line 1100 is well above the trend line 1102), the portfolio would almost always run out sooner than the 30 years of sustainable income targeted in this instance for success. This exhaustion of the portfolio, in which the investor loses both the asset and the corresponding income, may be referred to as “downside failure.”

Conversely, applying the same 5% draw rate to a portfolio that is inexpensively priced (e.g., when the total return line 1100 is well below the trend line 1102) would likely result in the portfolio failing to the upside. “Upside failure” is where much more income could have been taken and was not, such that the portfolio grows to a much higher level than it started with and the retiree shortchanged his or her lifestyle.

The data used to create the graph of FIG. 1A enables analyses of roughly 1390 30-year periods, showing the results of drawing 30 years of income from a hypothetical portfolio starting at all the possible start dates available within the data from back in December 1801 through the 30-year period that ends in December 2012. These periods may be referred to as “rolling return” periods. The analyses may start on every December using the annual data available from 1801 to 1870 and then the monthly data from 1871 forward, e.g., January 1871, February 1871, March 1871, etc. Other embodiments may use quarterly, monthly, or daily data to further refine this process.

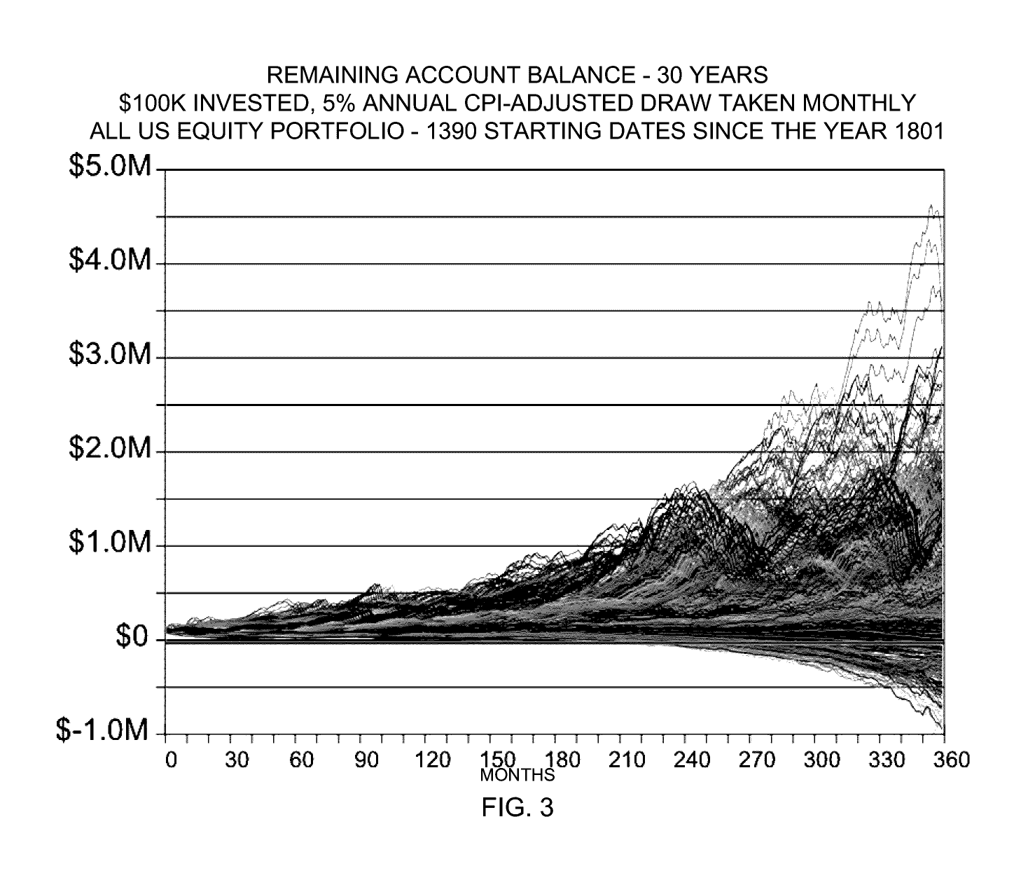

FIG. 3 is a graph showing the erratic outcome of a traditional approach that uses only the starting portfolio price to set the first of 30-years-worth of steady inflation-adjusted withdrawals. Each line shown in the graph of FIG. 3 represents what actually would have happened to the value of a $100,000 portfolio over 30 years, if a gross withdrawal rate of $416.67 per month (5% per year) commenced on a particular start date, and then was adjusted only for actual inflation or deflation going forward. As shown in the graph, the lines represent data series resulting from 1390 different start dates since the year 1801, and begin from month zero (the starting month), so that the distribution of outcomes of the different start dates can be compared.

As shown in FIG. 3, the results vary dramatically with a very wide distribution of outcomes showing both downside and upside failures. The lines on the graph that continue below zero indicate which of the outcomes fail to the downside, though in reality, of course, after reaching zero, the withdrawals would cease and the portfolio would end. In addition, the uppermost and lowermost lines show the starting periods that diverge most dramatically. The result is that roughly one in five these tests ends in downside failure—meaning the portfolio ran out of money before 30 years were up.

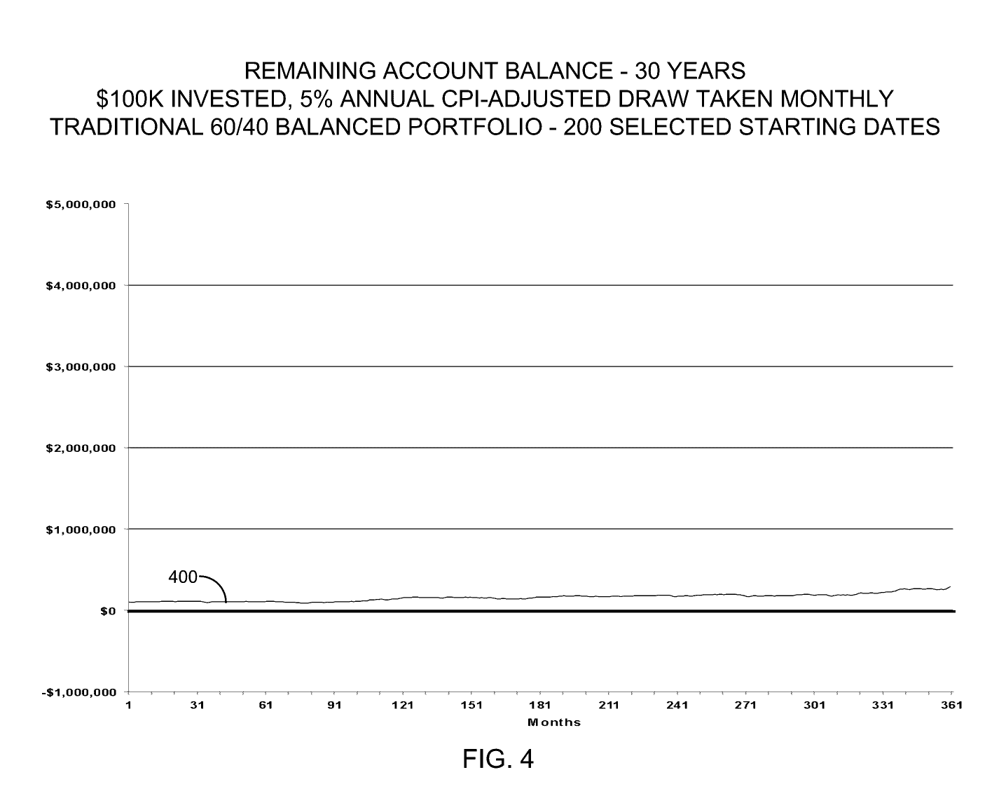

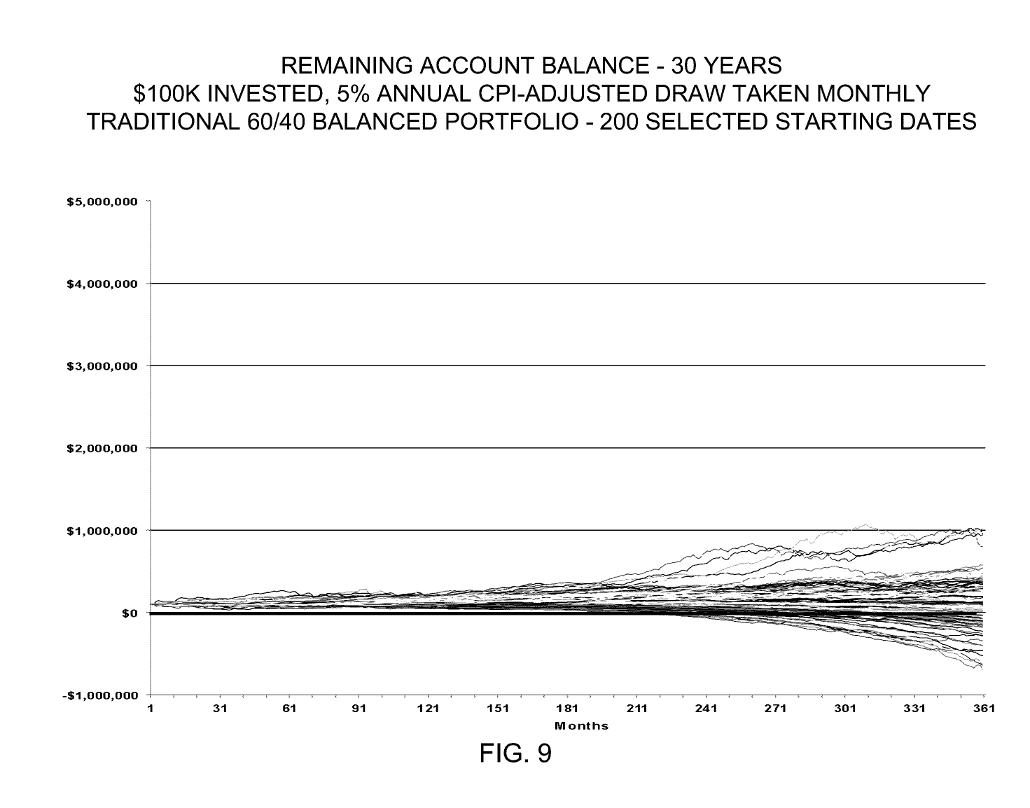

To be clear, this data represents using a portfolio constructed from holdings contained in the broad based U.S. stock market. One possible way to reduce the failures may be through diversification among other asset classes, preferably non-correlating in price movements. However, when bond holdings are introduced in the usual way to create a traditional 60% stock and 40% bond “balanced” portfolio (with the mix rebalanced constantly), the results actually get worse, failing roughly one out of every four attempts, versus one out of every five attempts for the all stock portfolio. FIGS. 4-9 are graphs illustrating a distribution of outcomes for an exemplary balanced portfolio. FIGS. 4-8 are used to help understand the way these distribution graphs are built up as described below. FIG. 9 shows the full distribution of outcomes when the 30-year results of all 1390 individual starting dates are graphed together.

FIG. 4 illustrates an account value 400 over 30 years starting with $100,000 invested in January 1871 in a traditional 60/40 balanced portfolio, with a starting withdrawal rate of 5% ($416.67/month) adjusted for inflation going forward.

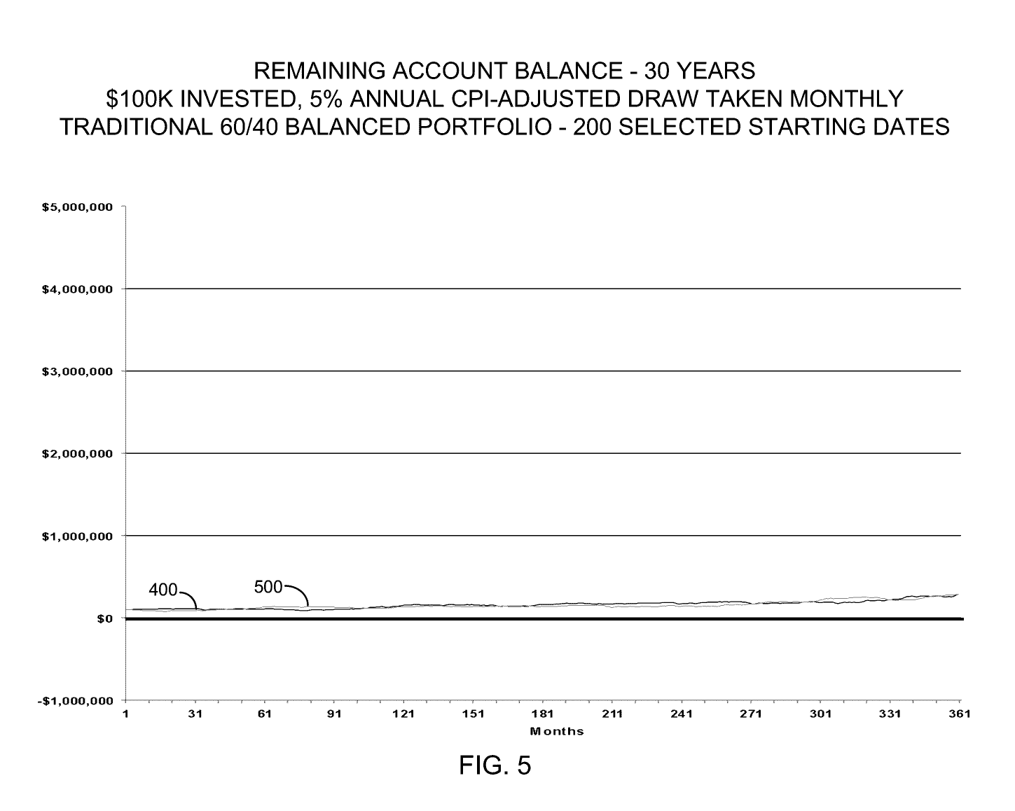

FIG. 5 illustrates a second account value 500 starting in February 1871 with the same parameters, i.e., over 30 years starting with $100,000 in a traditional 60/40 balanced portfolio, with a starting withdrawal rate of 5% ($416.67/month) adjusted for inflation going forward

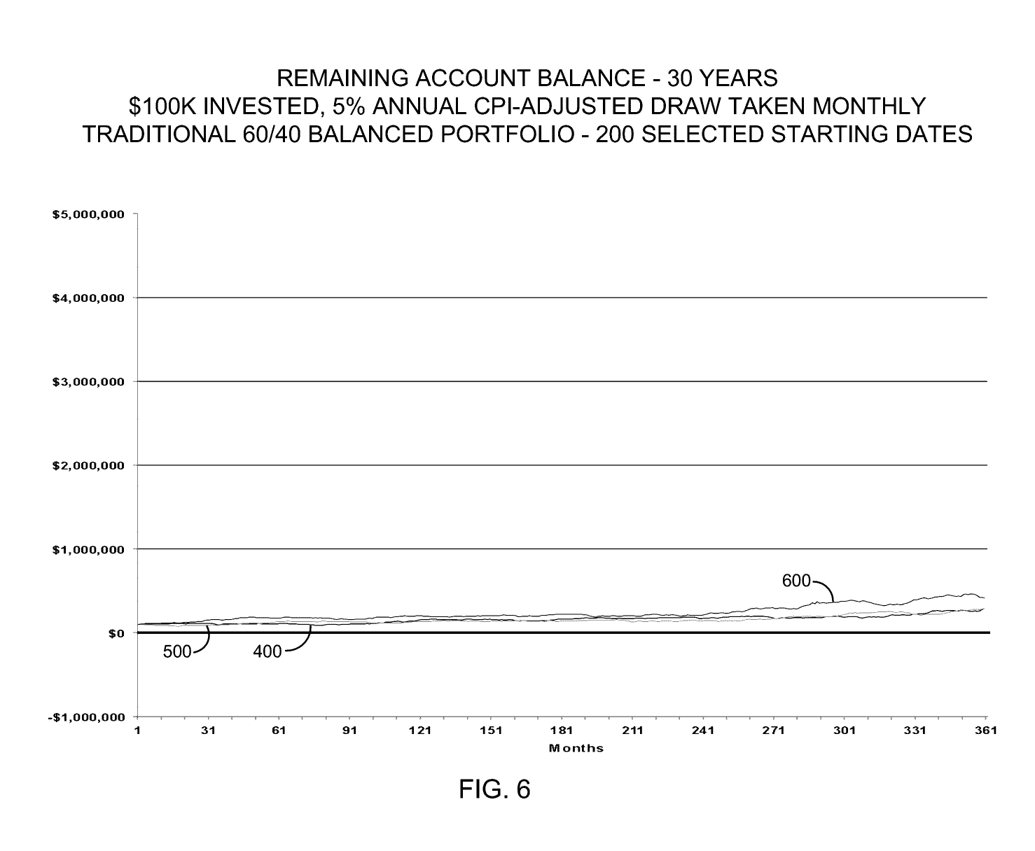

FIG. 6 illustrates a third account value 600 in the same manner.

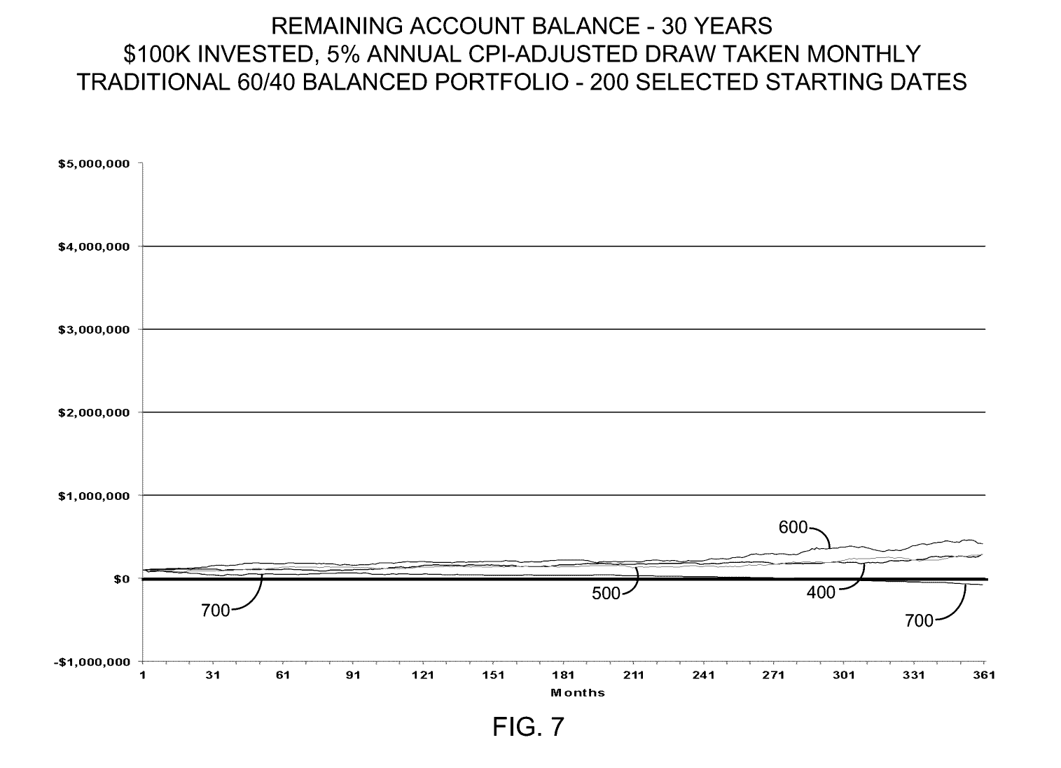

FIG. 7 illustrates a fourth account value 700 that ends in zero funds, representing a downside failure.

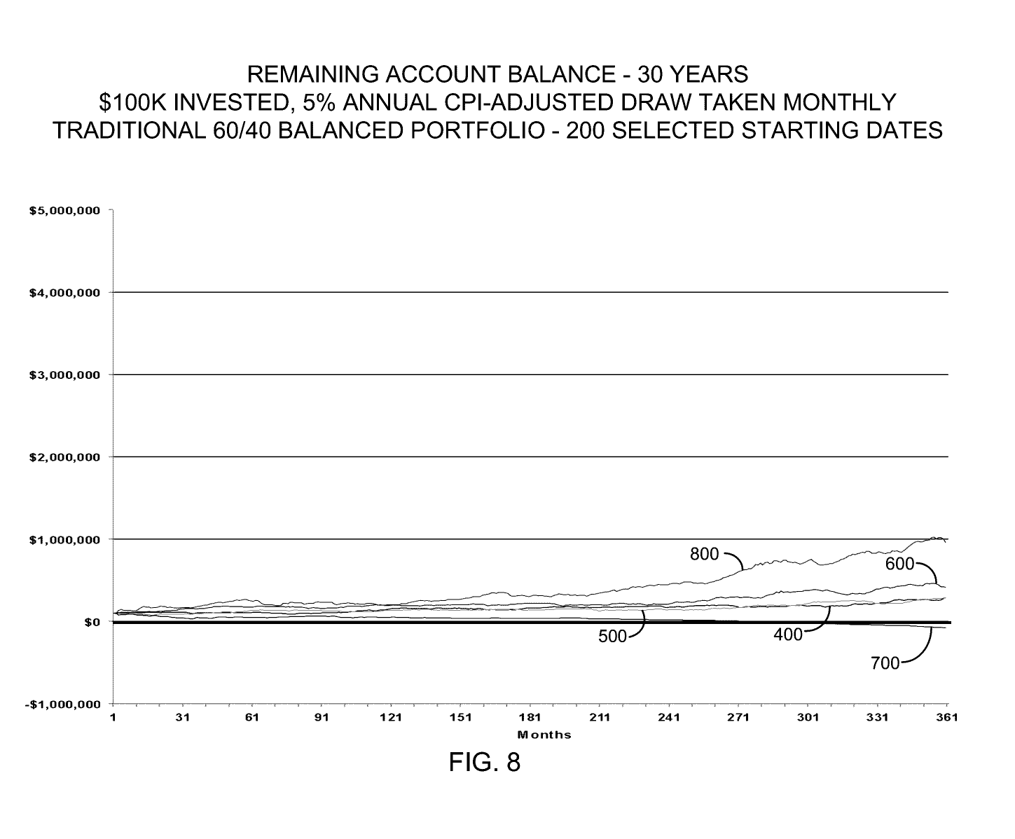

FIG. 8 illustrates a fifth account value 800 that may represent an upside failure. Recalling the question of trying to find the “most” (the largest successful monthly paycheck) that an investor can take safely (without running out money during retirement), this portfolio ended with ten times more money than the investor started with, showing that the investor did not take the most he could have.

FIG. 9 illustrates 200 starting dates, 60 of the most extreme account value results, plus the account values that result from all January starting dates of every year starting in 1871. As shown, there are a significant number of both downside failures and upside failures. Slightly more than 28% of these cases failed to the downside when using a gross starting withdrawal rate of 5% by running out of money, and an even greater percentage—over half—ended up with significantly more than they started with, which means the investor could have taken considerably more income, but did not. These withdrawal rate are gross withdrawal rates that do not yet include real world portfolio costs, which if added in would, of course, significantly degrade the results.

As seen in FIGS. 4-9, compared to the all-equity portfolio of FIG. 3, the failure rate for the balanced portfolio is higher, at roughly one in four failures. What does improve by using the balanced stock and bond approach relative to the all-equity portfolio is the narrowing of the range of the distribution and the fact that the first failure moves out a number of years—but the ultimate failure rate is still higher. Thus, the volatility is reduced, but the portfolio earns less, which ends in more frequent failure and a less successful result to the fundamental question posed. In order to create an outcome in this scenario with no downside failures, the gross draw rate would have to be reduced to less than 3% per year, which would in turn have the counter effect of greatly increasing the number of upside failures. It turns out that diversifying the stock portfolio with lower earning asset class investments just lowers the total performance of the investment portfolio and results in a smaller safe withdrawal rate. It could be shown that this same effect happens with any other traditional asset class such as cash instruments, gold, or other commodities.

In comparing FIGS. 9 and 3, the all-equity portfolio yields more variance, but actually a better outcome for downside failures, slightly less than 1 in 5, yet far more upside failures. Thus, the stocks failed significantly less often, but more dramatically in both directions. The first downside failure happened at about 20 years with the balanced portfolio as compared to at about 12 years for the first all stock portfolio failure. Although the equities earned more on average than the balanced portfolio and performed better in terms of downside failure, both the results and the variance of both strategies is unacceptably wide. While the gross distribution rate for the balanced portfolio would have had to be limited to about 3% annually, the gross distribution rate for the all-equity portfolio would have had to be limited to 3.7% in order to have never failed—which would equate to about 23% more income for the retiree.

Returning to the pure stock example, the most dramatic downside failure in the period analyzed occurred when the income was started at the very peak of the data at the dawn of the Great Depression market in September of 1929. That example fails roughly 12 years out. Conversely, the greatest upside failure came when starting at the very bottom shown in the data during the very depths of the Great Depression crash in stock prices, June 1932, which results in a portfolio value that grows from $100,000 to over $4 million—over 40 times the starting amount. Clearly, the investor could have taken a more ample income, all the more important because at that moment in time, the starting portfolio amount would have been significantly compressed resulting in a very small paycheck using the traditional approach and a 5% draw level.

As demonstrated in FIG. 3, picking a draw rate percentage low enough to be called safe so that there are no resulting downside failures does not work well because it does not consider the valuation of the underlying portfolio and will result in a large proportion of upside failures. It most often turns out to have been overly cautious resulting in investors or retirees shortchanging the lifestyle they could have otherwise enjoyed.

To mitigate these failures, the present embodiments determine a far more reliable safe withdrawal rate using a valuation process that may render volatility far less relevant and more safely allow investors to access the historically more consistent higher returns provided by owning stocks as the investment vehicle. The process may be applied to any diversified portfolio including other asset classes, but may be most valuable when applied to an all stock portfolio. This process may be referred to as “value gap income planning,” the “value gap approach,” or the “value gap method.” According to the present embodiments, instead of basing the expected “safe” withdrawal amount on the randomly fluctuating portfolio price (e.g., the total return line 1100 in FIG. 1A), value gap income planning bases the withdrawal amount on the estimated internal value as represented by the trend line 1102, regardless of where the then current price level may be. In an embodiment, one would most likely calculate traditionally on price using a “target” safe withdrawal rate, e.g., up to 5.3%, if the underlying portfolio was constructed to closely mirror the Standard & Poor's 500 Index™, which is then adjusted by the “value gap” factor to achieve the desired result. In a basic implementation, an investor may adjust the starting withdrawal by the proportional difference between the current portfolio price and an amount that represents some manner of estimate of the average value of past price fluctuations at that time—thereby accounting for the fact that the portfolio at that time may be overpriced or underpriced. In particular, in an embodiment, a safe withdrawal amount may be calculated by the following formula:

Safe withdrawal amount=(starting balance of portfolio)×(target safe withdrawal percent)×(1/(value gap))

Application of this method for the U.S. stock portfolio represented herein would have historically eliminated downside failure and greatly mitigated upside failure, thereby very elegantly improving the reliability of the outcome to an age-old challenge for millions of investors. Indeed, by adjusting withdrawal rate by the “value gap,” downside and upside failures may be meaningfully reduced, and sustainability and predictability of outcomes over long periods of time may be meaningfully increased.

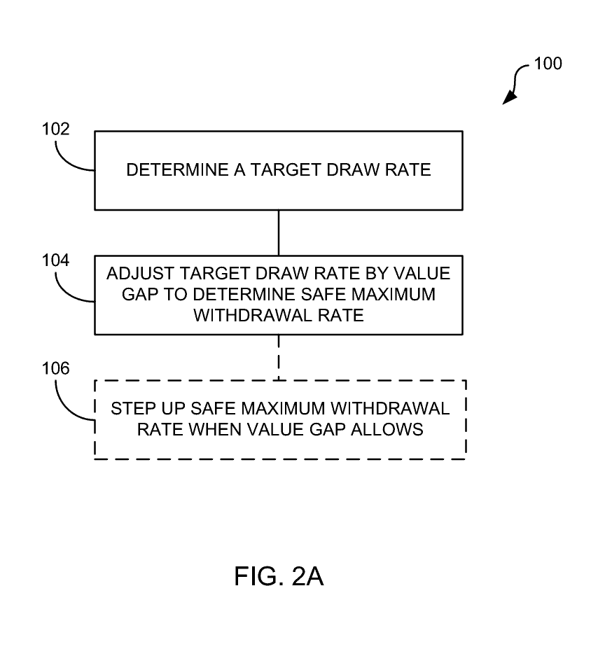

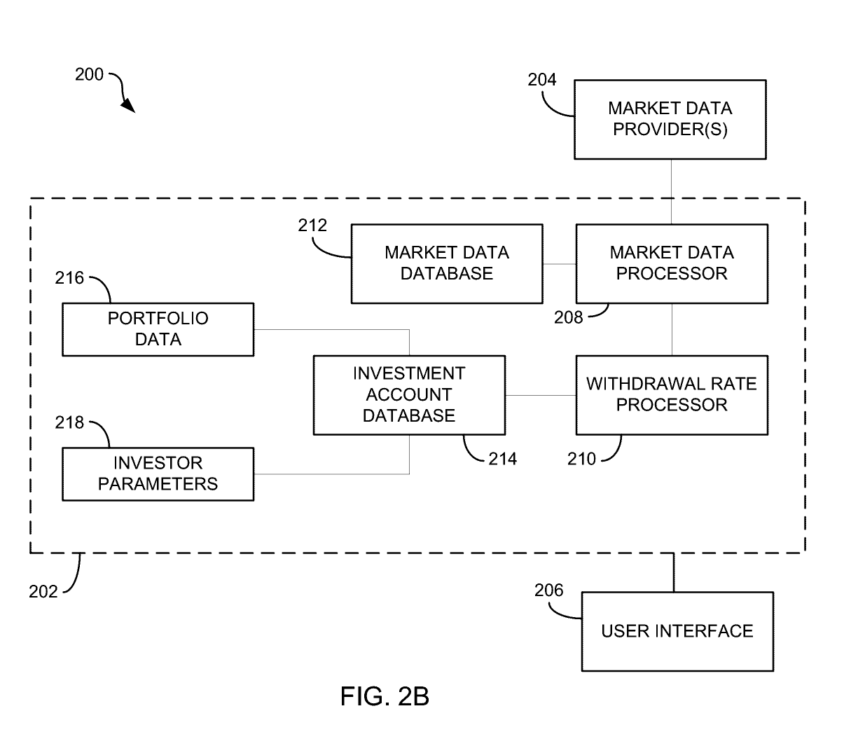

FIG. 2A illustrates an embodiment of a method 100 for determining a safe income withdrawal rate from an investment account. As shown, method 100 begins in step 102 by determining a target draw rate, or target safe withdrawal percent. The target draw rate may be a percentage of the starting portfolio value adjusted for inflation going forward and may be based on the time over which income is desired. For example, if income is desired over 10 years, then a target draw rate can be set that correlates with 10 year periods of 100% historically successful outcomes (no downside failures). If income is desired over 30 years, then a target draw rate can be set that correlates with 30 years of such historically successful outcomes. The target draw rate for 10 years would be higher than the target draw rate for 30 years. As an example, a target draw rate may be 5.3% of a starting portfolio value adjusted for inflation going forward for 30 years, which percentage may be based on a trend of historical U.S. equity market data. As described above, based on historical data, 5.3% may be a level of draw rate that works well any time price is at or near the estimated internal value (e.g., when the total return line 1100 and trend line 1102 of FIG. 1A are at the same level).

In one embodiment, a method for determining a target draw rate comprises back testing a significant amount of historical data that included historically extreme variances. In doing so, the target draw rate may be considered the largest withdrawal rate that had successfully resulted in whatever parameters the investor chose. In some embodiments, that target draw rate may be chosen as that highest level that resulted in no historical downside failures. Alternatively, the target draw rate may be chosen based on different outcomes, e.g., 90% of the outcomes with no downside failures or 100% of remaining portfolio balances at the end of thirty years being no less than the starting portfolio amount.

With the target draw rate determined, the method 100 continues in step 104 by adjusting the target draw rate by a value gap, to determine a safe maximum withdrawal rate. The value gap may be determined by observing the difference in the value of the portfolio relative to a market trend line used to estimate internal value. For example, referring to FIG. 1A, the value gap may be represented by the line 1104, which is determined by the proportional difference between the total return line 1100 and the trend line 1102. As explained above, the safe maximum withdrawal rate may be calculated by multiplying the starting balance of the portfolio by the target safe withdrawal percent (or target draw rate) and by the multiplicative inverse of the value gap. In adjusting the first and subsequent target distributions (e.g., monthly paycheck) by the value gap, the investor may then preferably maintain constant purchasing power going forward by adjusting the subsequent paychecks periodically in line with CPI measures. This may then result in a far higher probability that the investor will avoid running out of funds during the time frame set by the target draw rate, than would have otherwise occurred without the value gap adjustment. It should be noted that the value gap method may not require this inflation adjustment and that the method may be employed without inflation adjustment, perhaps resulting in less reliable outcomes. In embodiments, target draw rates solved for as described above are solved for in the same manner as income will be withdrawn, e.g., with or without accounting for price inflation. This adjusted first distribution is then the safe maximum withdrawal amount. Its annualized percentage of the total portfolio value would be the “safe annual withdrawal rate.”

In practice, the value gap may be designated as a “value gap index” that may provide a convenient factor to be used in the initial income adjustment formula. For example, the value gap index may be determined by dividing the total real return by the trend line or best fit (i.e., (total return)/(best fit)), and the multiplicative inverse of the value gap index may be equal to a value gap multiplier that is multiplied by the target safe withdrawal percent to determine a value gap factor. The value gap factor may then be multiplied by the account balance to determine the safe withdrawal amount. These exemplary calculations are shown in the formulas below:

Value gap index=(total return)/(best fit)

Value gap multiplier=(1/(value gap index))

Value gap factor=(target safe withdrawal percent)×(value gap multiplier)

Safe withdrawal amount=(starting balance of portfolio)×(value gap factor)

FIG. 1B is a graph that illustrates an embodiment of a value gap index. In this example, line 1106 represents the value gap index for large U.S. stocks from 1871 to 2011, and a value of 100 represents the point at which the real price and internal value are aligned. Notably, in this example, the real price has historically remained within a range of about half of the internal value to about double the internal value.

The market trend data used to calculate an “estimated internal value” may be determined based on historical data of the particular investments in an investment account, of wider samples of a market, or of a market as a whole. Of course, the effectiveness of such is increased based on the breadth of the number of holdings covered and perhaps even more importantly the length of time such data has had to experience various economic conditions. It is believed that at least three human generations makes for highly useful data, although shorter periods may still be useful. Alternative embodiments may be based on expected correlation. For instance, if an investor were using a portfolio strategy that lacks sufficient data to generate a useful internal value estimate or for any other reason, the investor may utilize the value gap data from another historical portfolio that is believed to have similar volatility characteristics in some manner and then apply a value gap factor to the investor's own portfolio.

Although embodiments described above use trend line 1102 to determine estimated internal value of a portfolio, alternative embodiments may use other techniques that smooth out volatility to estimate internal value. For example, an alternative embodiment may create a long moving average line that resembles a regression line but curves somewhat to follow the price data. As another example, a ruler or other edge may be placed over graphical data to “eyeball” where an internal value best fit trend line falls. Accordingly, notwithstanding the particular benefits associated with using trend line 1102 and regression analyses, the present embodiments should be considered broadly applicable to any data smoothing techniques for creating an approximating function that captures important patterns in data, and to any techniques for determining estimated internal value based on those data smoothing techniques. As described herein, determining withdrawal amounts based on an internal value represented by a “smooth” estimate may provide improved results over determining withdrawal amounts based on randomly and erratically fluctuating actual portfolio prices.

After determining the safe maximum withdrawal rate, the investor may continue to receive income from the portfolio at that rate, expecting a significantly higher probability that the portfolio should survive without a downside failure or a significant upside failure. However, optionally, in an alternative embodiment, the investor may elect to take advantage of market conditions and increase the safe maximum withdrawal rate where possible. In this situation, as shown in FIG. 2A, the method 100 may continue optionally (as represented by the dashed lines) in step 106 by permanently stepping up the ongoing income (calculated separately from inflation or deflation adjustments) when the value gap analysis allows. In other words, the withdrawal rate is adjusted any time that the value gap adjustment would create a larger “safe” monthly paycheck as if the current month were a new starting month. Thus, going forward, if the then-current value-gap calculation shows an available income amount that is greater than the current income amount, then the investor may permanently “step-up” their income to that amount—if they want to. This adjustment involves examining the current safe maximum withdrawal rate against a current value gap calculation and, if possible and desirable, adjusting the current safe maximum withdrawal rate upwards, but not down. Step 106 may be executed continually (e.g., as market data is received and compiled), periodically (e.g., daily, monthly, or annually), timed with the income withdrawals from a portfolio (e.g., before a quarterly paycheck is issued to the investor), or on demand (e.g., at the request of an investor or financial advisor).

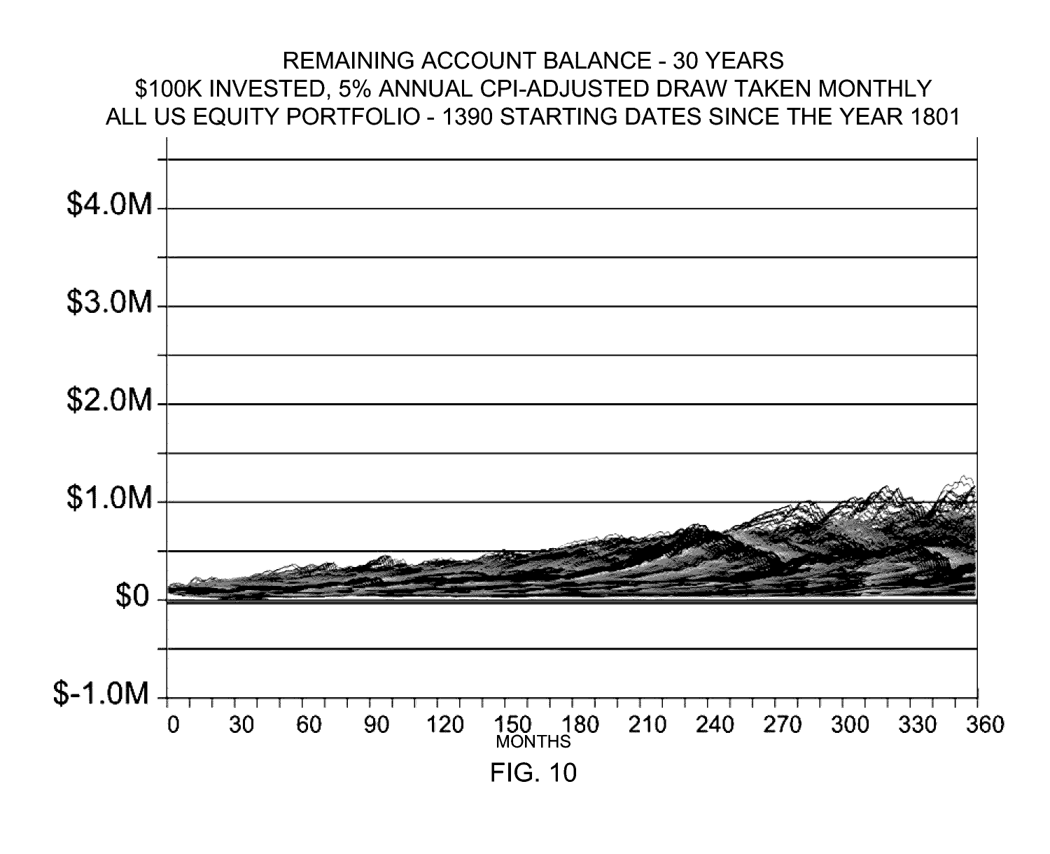

FIG. 10 is a graph that illustrates what happens when the first paycheck from each data series in the example of FIG. 3 described above, is “value gap adjusted” by the proportional difference between the total return line 1100 and the trend line 1102. FIG. 1A shows that proportional difference as line 1104, referred to herein as the value gap index line 1104. The income is then re-adjusted thereafter any time that a value gap test would create an increase in the monthly income. Such an increase may be referred to as a “step-up” and may amount to a permanent pay raise, again calculated separately from future inflation or deflation adjustments.

Comparing the graph of FIG. 10 to the graph of FIG. 3, the improvement in the outcomes of FIG. 10 is dramatic, resulting in zero downside failures over every one of the 1390 periods of data available for the last 200 years. The valuation process of the present embodiments would have allowed the investor in every case to take a steady paycheck adjusted for actual inflation for at least 30 years without ever running out of money. The present embodiments would have caused people to prudently take less when their portfolio price was excessively high. Conversely, the present embodiments would inform investors that they could take more than they otherwise would have when their portfolio price was overly compressed—a seemingly high percentage of withdrawal—yet without ever failing. The present embodiments would also have allowed people to take a permanent raise in their income when possible still without fail. In practice, going forward from a time prior to the Great Depression, using a broadly diversified portfolio of large U.S. stocks, possibly through the use of a mutual fund or other such investment vehicle, one could have done this using only the information available at the time with no necessary future prediction ability, no complex investment management, and with an expected precision that has never been seen before.

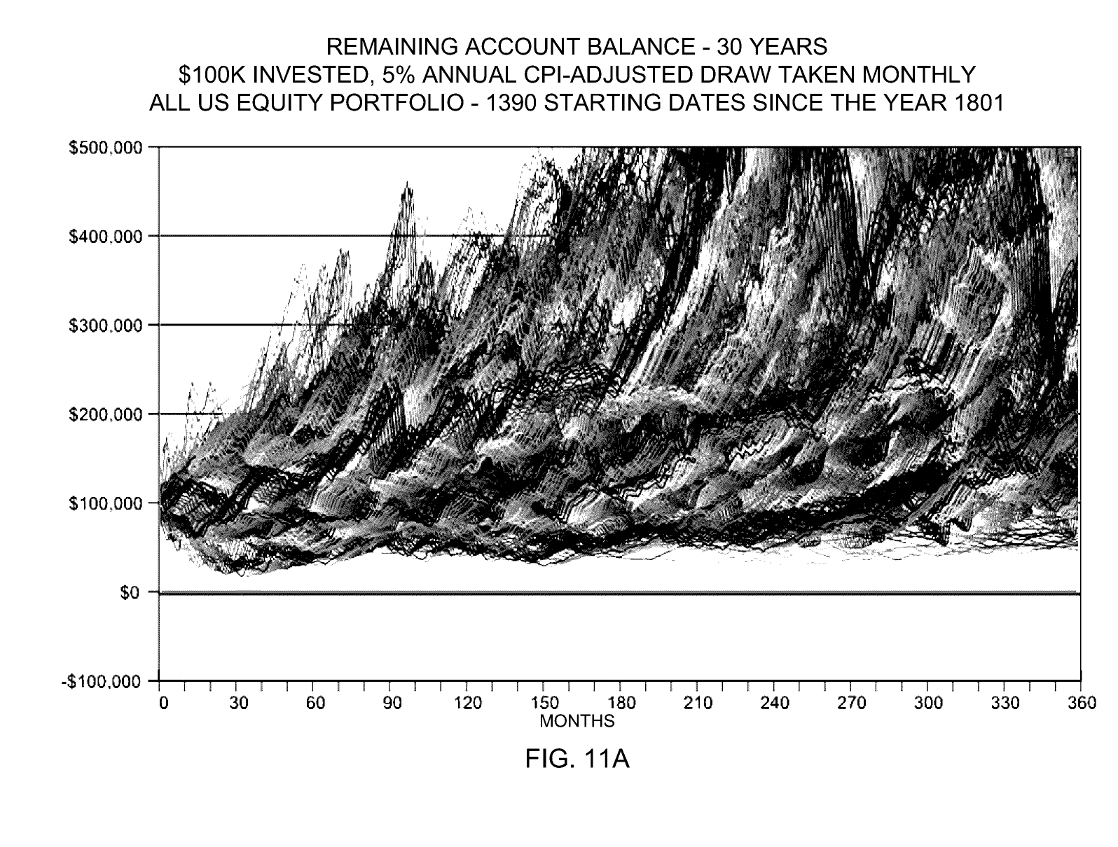

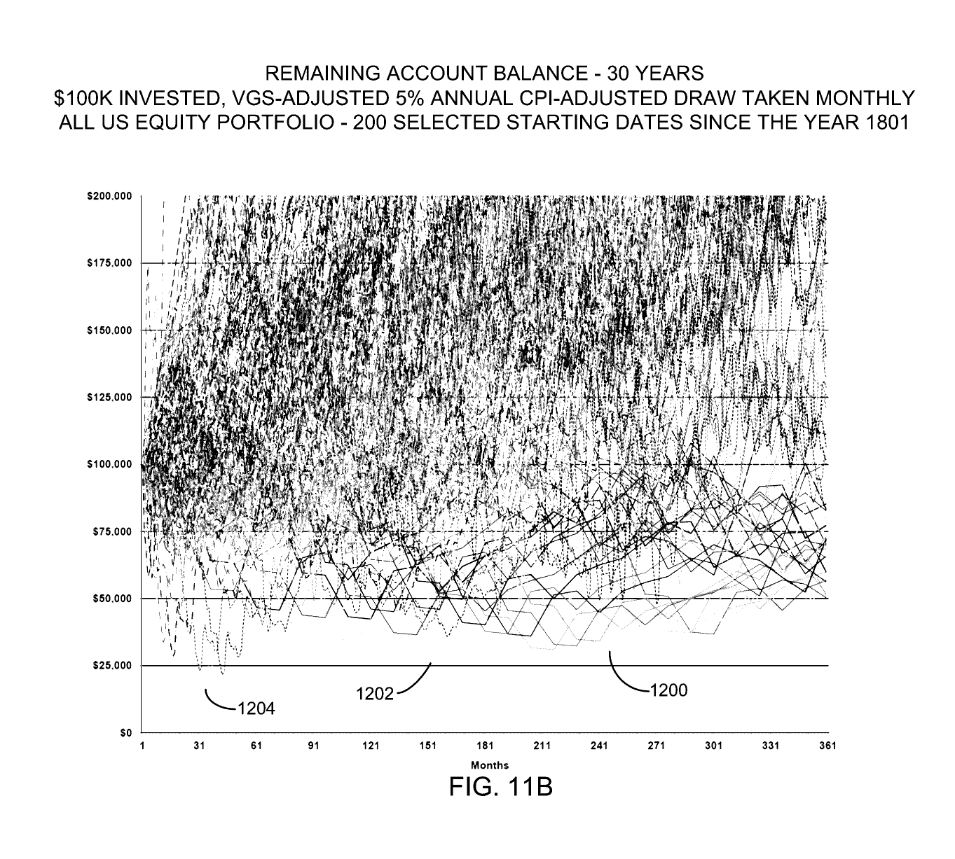

Due to the many data series, it may be difficult to see in the graph of FIG. 10 that none of the results actually touches zero. To provide a better view of this, FIG. 11A illustrates the same graph as FIG. 10 zoomed in on the y-axis and scaled from −$100,000 to $500,000 to clearly illustrate no downside failures.

For further clarity, FIG. 11B illustrates lines for 200 selected starting dates of the data of FIG. 10, representing only the most critical starting periods that diverge most dramatically, as well as those that start in each December since the year 1801. FIG. 11B is also zoomed in on the y-axis and is scaled from $0 to $200,000.

In the graph of FIG. 11B, the geometric-looking data lines (e.g., line 1200) around the bottom show the older annual data, while the more granular data lines (e.g., line 1202) are monthly series from 1871 onward. Around month 32, the worst case line 1204 peeking out at the bottom is the data series starting at the height of the Great Depression and drops from the starting balance of $100,000 to a little over $15,800 only 32 months later—and yet still never hits zero even with multiple permanent raises at times going forward. The data lines of the graph of FIG. 11B assume a flat 5% target withdrawal rate, but the present embodiments have been applied to an actual maximum of 5.3% resulting in zero failures using this data.

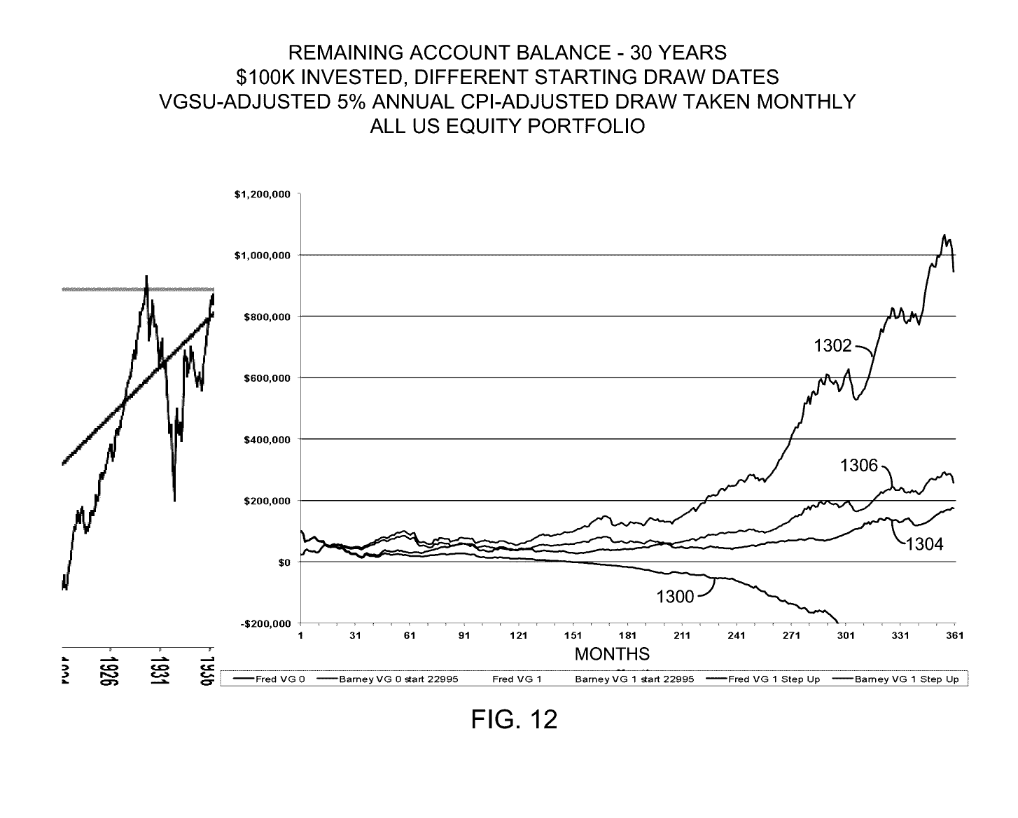

As another example of the present embodiments, FIG. 12 illustrates the account values of two portfolios, comparing the results of traditional withdrawal rates to the results of present embodiments of withdrawal rates applying a value gap adjustment. It shows the resulting balance of a first investor who retired near the top of the stock market cycle during the beginning of the Great Depression and a second investor who retired near the bottom of the stock market cycle during the beginning of the Great Depression. They were otherwise identical. The data shows results for each investor from their respective dates of retirement. Lines 1300 and 1302 illustrate a first and second investment portfolio, respectively. The first investment portfolio represented by line 1300 starts on a starting draw date (e.g., retirement date) of September 1929 with $100,000 invested in all equities, with a 5% annual CPI-adjusted draw taken monthly over 30 years and without a value gap adjustment. The second investment portfolio assumes the same starting account value of $100,000 on September 1929, but a starting draw date (e.g., retirement date) of March 1932 (32 months after the first investor) at which point the account value has fallen to $22,995 because of the significant market downturn. The second investment portfolio represented by line 1302 therefore starts on March 1932 with $22,995 invested in all equities, with a 5% annual CPI-adjusted draw taken monthly over 30 years and without a value gap adjustment.

As shown by line 1300, under these circumstances, the first investment portfolio would reach zero after about 151 months. As shown by line 1302, the second investment portfolio would grow to about $1,000,000 by 30 years out. Lines 1304 and 1306 illustrate how applying a value gap adjustment (including stepping up) to the first and second investment portfolios, respectively, under the same circumstances, avoids the failures represented by lines 1300 and 1302. As shown by line 1304, the first investment portfolio maintains its value over the 30 years, ending that period with a value around $200,000, as the investor had successfully adjusted the draw rate down to one that allowed the portfolio to survive in spite of the massive market price drop in the early years. Likewise, as shown by line 1306, the second investment portfolio maintains its value over the 30 years, ending that period with a value around $250,000, as the investor took significantly more income and successfully enjoyed a far more comfortable lifestyle, than would otherwise have been expected to be sustainable using conventional methods.

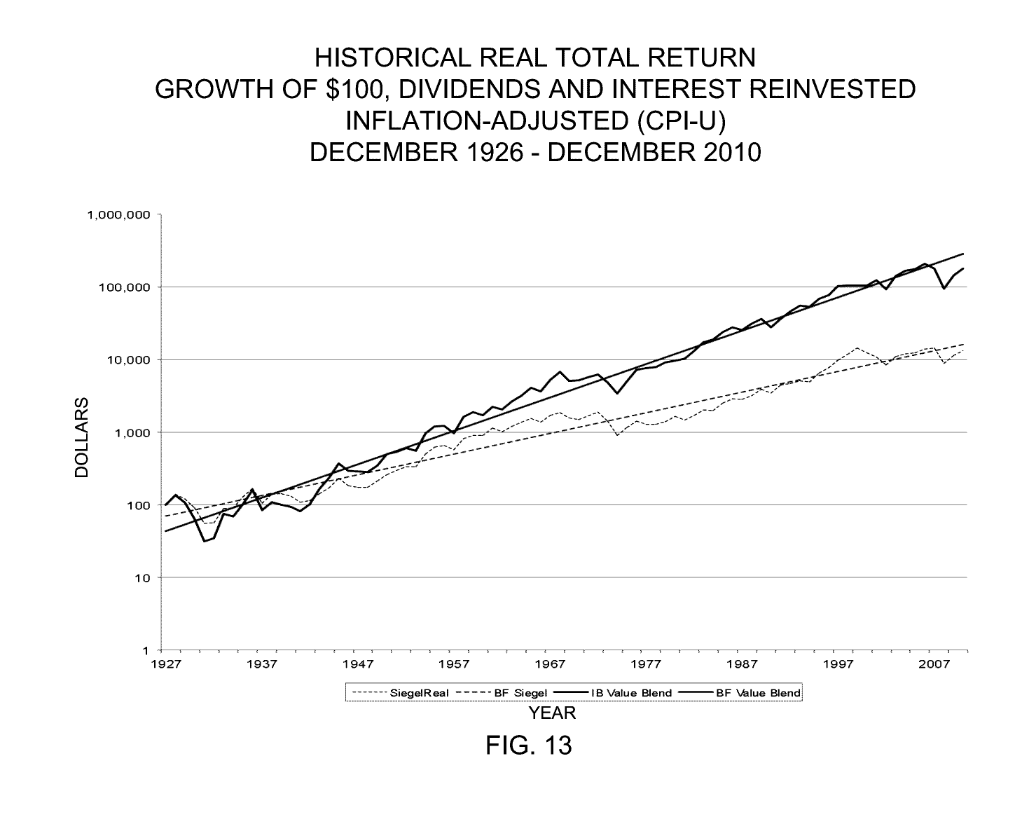

FIGS. 13-15 illustrate another embodiment of a system and method for determining a safe income withdrawal rate from an investment account, demonstrating the value gap approach may be applied to various investment portfolio options. This embodiment uses value stocks rather than the broad all-equity portfolios described above, and is based on about 53 periods of annual back data. The fund may be a blend of 50% large value and 50% small value.

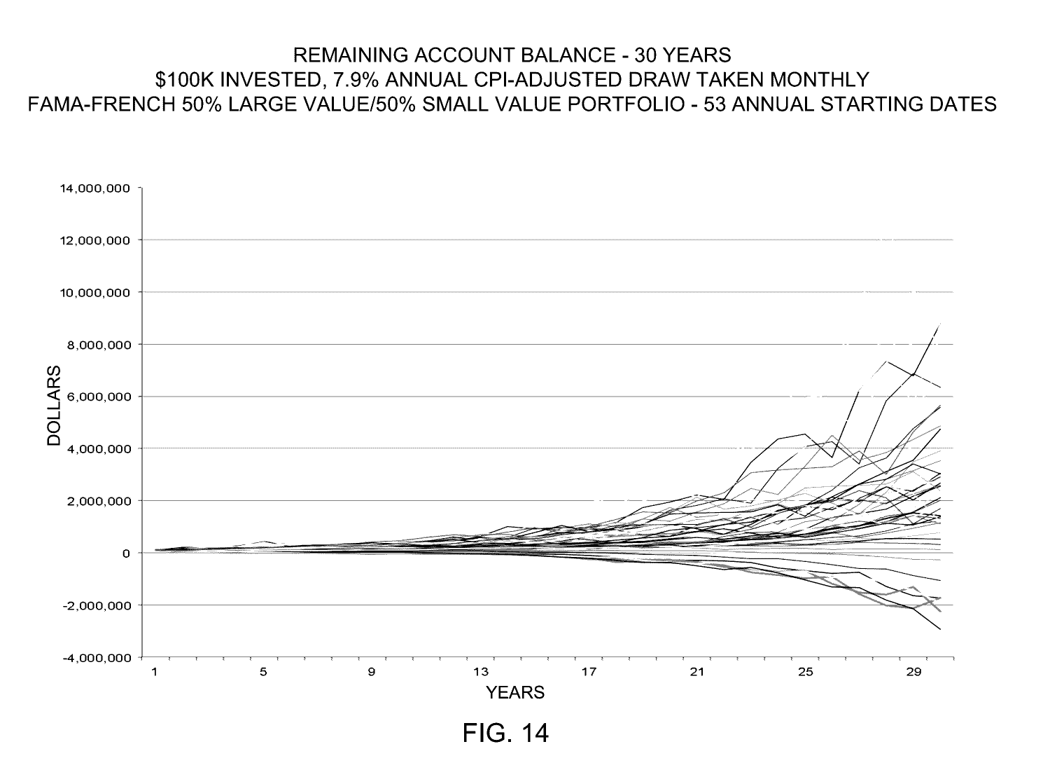

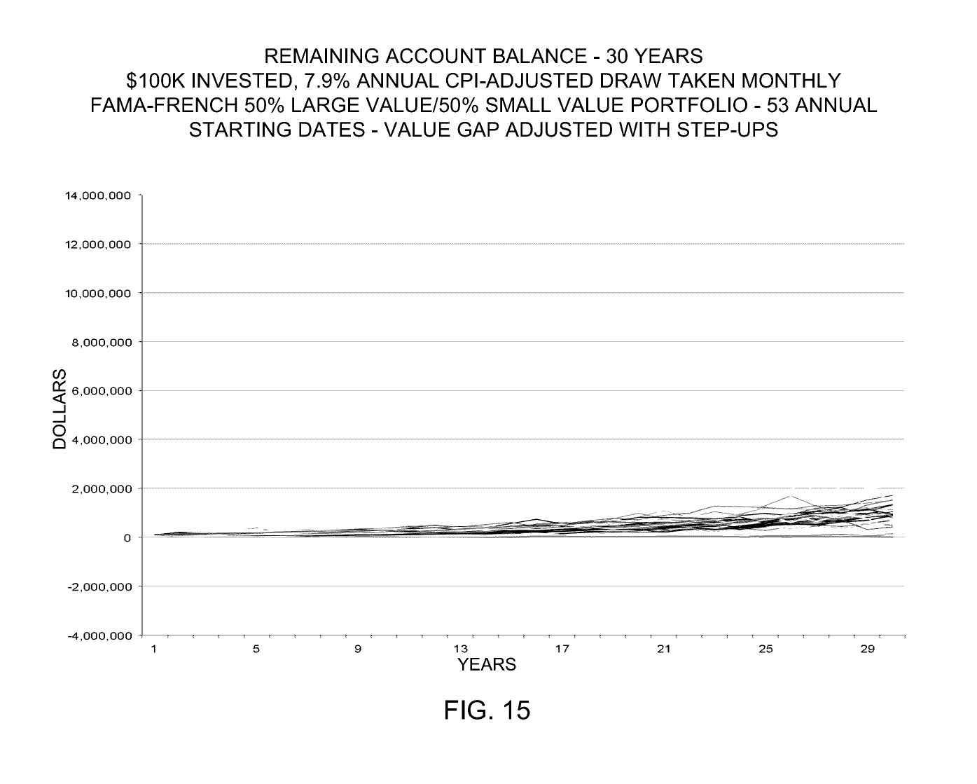

In FIG. 13, the dotted lines represent broad U.S. stock data. The solid lines are a 50/50 value blend of the Fama-French data as found in the 2011 Ibbotson SBBI yearbook. Note the similar cycles and volatility but steeper slope as compared to the broad U.S. Stock data. This allows more gross distribution (about 7.9% with no failures). This approach may allow approximately 2.5% or more annual flow to cover the costs of a real world product and a professional advisor, while still leaving about 5% or more of annual income based on the estimated internal value (adjusted for inflation) for the investor's income—with no historical downside failures. The entire gross distribution, including the individual portions (e.g., the approximately 2.5% and 5%), may be value gap adjusted as described herein. While the investor's income may be stepped up permanently as described above, it may be expected that the portfolio costs would be based solely on the internal value and receive neither steps up or down nor any independent inflation adjustment. FIG. 15 shows remaining account balances over 30 years, for $100,000 investments, with a 7.9% annual CPI-adjusted draw taken monthly, based on a portfolio construction of Fama-French 50% Large Value/50% Small Value. FIG. 15 shows data series for all available 53 annual starting dates from 1927 to 1980. The income is value gap adjusted based on the estimated internal value as calculated in this case by the method of logarithmic regression of the Fama-French portfolio data and includes step-ups where possible. As shown in FIG. 15, this value gap adjusted example results in no failures. In contrast, FIG. 14 shows that the same scenario without value gap adjustment results in many failures. The data lines represent remaining account balances over 30 years, for $100,000 initial investments, with a 7.9% annual CPI-adjusted draw taken monthly, based on a Fama-French 50% Large Value/50% Small Value Blended Portfolio, showing all available 53 annual starting dates from 1927 to 1980, without any value gap adjustment, and with many upside and downside failures. FIGS. 13-15 therefore shows that the value gap method dramatically improves results over a traditional method, when using the same gross draw rate percentage of 7.9% annually based on the starting account value. As can clearly be seen, the value gap adjusted approach shown in FIG. 15, with the same 7.9% target, yielded no downside failures and significantly reduced upside failures.

FIGS. 13-15 demonstrate the commercial applicability of present embodiments to the Variable Annuity or mutual fund industry as further explained below. In particular, the embodiment of FIGS. 13-15 uses data from the historically better performing Fama-French portfolio as the basis for both the fund and the estimated internal value (e.g., based on the best fit line or trend line). The difference in return due to this better performance may be used to cover insurance premiums and other fees associated with a variable annuity product and a guaranteed minimum withdrawal benefit or other such living benefit, while still allowing a steady inflation-adjusted beneficial income distribution to the investor. In addition, the investor benefits from the insurance coverage, providing income to the investor in the event that the investor outlives the actual term of the income withdrawals. The Fama-French 50% Large Value/50% Small Value Portfolio illustrated in FIG. 13 is one example of a portfolio that has historically outperformed the broad U.S. stock market, thereby providing a margin over performance of the broad U.S. stock market from which to fund insurance coverage and other fees associated with variable annuities. Other superior performing portfolios are possible.

As represented by FIGS. 13-15, embodiments may provide methods for managing distributions associated with an investment account that involve determining a subset of securities of a broad market, preferably equities in a broadly diversified portfolio that has historically outperformed the broad equity market, wherein the subset of securities historically provided a higher return versus a lower return of the broad market; determining a target draw rate; determining, using a computer processor, a value gap, wherein the value gap is the difference between a current value (e.g., current market price valuation) of the subset of securities and an estimated internal value of the subset of securities; adjusting, using a computer processor, the target draw rate by the value gap to determine a historically safe maximum withdrawal rate for the initial distribution; investing funds of the investment account in the subset of securities; distributing income to an owner of the investment account according to the safe maximum withdrawal rate; and using a difference between the higher return and the lower return to pay fees associated with the investment account. The investment account may include a variable annuity product and the fees may be associated with income insurance for an owner of the investment account. Fees associated with the investment account may be based on the estimated internal value as opposed to the current market price of the investment account.

Alternative embodiments may base the value gap adjustment on broad market data (e.g., broad equity market data), but then actually invest in a smaller subset of the market that has provided historically better returns than the broad market. These alternative embodiments based on portfolios that historically outperform the broad market may involve determining a target draw rate; adjusting the target draw rate by a value gap to determine a safe maximum withdrawal rate, wherein the value gap is determined based on data of a broad market (e.g., a broad equity market); investing funds of the investment account in a subset of securities of the broad market that has historically outperformed the broad market, wherein the subset provides a higher return than a lower return of the broad market; distributing income to an owner of the investment account according to the safe maximum withdrawal rate; and using a difference between the higher return and the lower return to pay fees associated with the investment account. The investment account may include a variable annuity product and the fees may be associated with income insurance for an owner of the investment account. In embodiments, part of the income according to the safe maximum withdrawal rate may be distributed to the owner of the investment account and a portion or all of the remaining available income by be used to pay fees associated with the investment account.

In other alternative embodiments, instead of calculating the safe maximum withdrawal rate by multiplying the starting balance of the portfolio by the target withdrawal percent and by the multiplicative inverse of the value gap index, the safe maximum withdrawal rate may be calculated by first multiplying the starting balance of the portfolio by the multiplicative inverse of the value gap index to determine a nominal balance, and then basing the withdrawals on the nominal balance instead of the starting balance. For example, for $100,000 starting portfolio balance with a value gap index of 0.50, the nominal balance would be $200,000.

The present embodiments may use historical market data from a variety of sources to determine total return lines and trend lines. Exemplary data sources include:
Professor William Sharpe, Nobel Laureate, Stanford, Managing Investment Portfolios: A Dynamic Process, 2nd edition 1990;
Center for Research in Security Prices (CRSP);
DFA, History of Economics and The Science of Investing;
Wm. Goetzmann and Philippe Jorion (Journal of Finance), Global Stock Markets and the Twentieth Century;
Dr. Robert Shiller, Arthur M. Okun Professor of Economics at Yale University, Professor of Finance and Fellow at the Yale School of Management, who provides monthly U.S. equity price, dividend, and inflation data from 1871 to the present day;
Dr. Jeremy Siegel, Russell E. Palmer Professor of Finance at the Wharton School of Business, who provides annual real and nominal data for various asset classes (e.g., equities, ten year government bonds, cash in the form of 6-month T-Bills, and gold) from 1801 to present;
Dr. Roger G. Ibbotson, Professor in the Practice of Finance at the Yale School of Management, Chairman of Ibbotson Associates in Chicago, author of Stocks, Bonds, Bills and Inflation Yearbook, Morningstar (published annually, 1983 to present); and
Eugene F. Fama and Kenneth R. French.

For purposes of the present embodiments, these sources of suitable historical data all seem to correlate well regardless of from where they mine their information. The graphs shown herein rely on data drawn from Dr. Robert Shiller, Dr. Jeremy Siegel, Dr. Roger Ibbotson, Dr. Eugene F. Fama, and Dr. Kenneth R. French.

FIG. 2B illustrates an embodiment of a system 200 for determining a safe maximum withdrawal rate. As shown, system 200 may include an investment account management system 202, which may be a computer software program, and which may be accessible and controllable by a user interface 206, such as a graphical user interface. The user interface 206 may enable a user to enter data into system 202, control the processing of system 202, view the results of the processing of system 202, and perform other functions for controlling and managing the data and data processing of system 202.

As further shown in FIG. 2B, system 200 may include one or more market data providers 204, which may provide the investment account management system 202 with historical and current market data that can be used to calculate total return data, for example, as described above in reference to total return line 1100 of FIG. 1A. The one or more market data providers 204 may be, for example, Dr. Robert Shiller, Dr. Jeremy Siegel, and Dr. Roger Ibbotson, as described above. The one or more market data providers 204 may provide data automatically in an electronic data feed.

The investment account management system 202 may include data feeds, databases, and processors for executing the method 100 of FIG. 2A. Although shown in FIG. 2B as separate components for the purposes of illustration, data feeds, databases, and processors may be combined or further separated as needed or appropriate, for example, to manage a computer implementation. In addition, some components shown as part of system 202 may instead be external to system 202, such as databases with which system 202 may remotely communicate.

As shown in FIG. 2B, an investment account management system 202 may include a market data processor 208 and withdrawal rate processor 210. The market data processor 208 may receive market data (e.g., historical and current) from the one or more market data providers 204 and may calculate a total return line and/or a trend line based on the market data, for example, as described above in reference to the total return line 1100 and the trend line 1102 of FIG. 1A. Market data processor 208 may perform calculations as it receives the data or may initially store the data in a market data database 212 and access the data at a later time. Market data processor 208 may also compile market data from multiple market data providers to develop desired total return data and trend data. Market data processor 208 may be suitably robust, e.g., in terms of memory and processing, to handle the large-scale calculations and the large volumes of data described herein. For example, market data processor 208 may be capable of the retrieval and processing of the data of several hundreds of markets and funds over a span of 200 years, and of iteratively modeling given user parameters against the data to determine desired results, such as a specified number of historical outcomes (e.g., downside failures), as described herein.

Withdrawal rate processor 210 may receive data from market data processor 208 and investment account database 214, and may calculate a value gap and a safe maximum withdrawal rate based on the value gap and the particular data of an investment account. The particular data of an investment account may include portfolio data 216 and investor parameters 218. Portfolio data 216 may include data regarding the particular equities, such as stocks and bonds, held by an investor in an investment account. The equity data may include equities held, total shares, share prices, and dollar amounts. Investor parameters 218 may include any data necessary to calculate a withdrawal rate from an investment account, such as the age of the investor, the risk tolerance of the investor, the desired number of years of income, and the expected or actual rate of inflation.

In executing the method 100 of FIG. 2A, the system 200 of FIG. 2B may be managed, controlled, and adapted by a user as desired. For example, through the user interface 206, a user may select the desired market data providers 208, receive and compile the data from those providers using market data processor 208, and may calculate safe maximum withdrawal rates based on that data and the particular investment account data using withdrawal rate processor 210. The calculation of safe maximum withdrawal rates may occur continually as new data is received, or may occur in response to a request by a user, for example, before a distribution is issued from an investment account.

Although the schematic diagram of FIG. 2B shows various system components separately for purposes of illustration and description, it is to be understood that multiple components may be combined into one component or that individual components may be further separated into subcomponents. For example, market database 212 and investment account database 214 may be a single database. As another example, market data processor 208 and withdrawal rate processor 210 may be a single computer processor.

Although the embodiments described above may involve the determination of a safe maximum withdrawal rate based on a particular time over which income is desired (e.g., 10 years or 30 years), a user may wish to determine target withdrawal rates and safe maximum withdrawal rates for different time horizons and compare the different safe maximum withdrawal rates resulting from those different time horizons. Accordingly, some embodiments may enable a user to determine safe maximum withdrawal rates for multiple time horizons.

As disclosed above in reference to FIG. 2A, determining a safe income withdrawal rate may begin by determining a target draw rate, which is based on a chosen time over which income is desired, such as 10 years or 30 years. The target draw rate may be determined to be the highest possible draw rate that achieves a desired percentage (e.g., 100%) of historically successful outcomes (no downside failures) over the chosen time. Since the target draw rate depends on the chosen time, different chosen times may be used to determine different target draw rates for each chosen time. Embodiments provide systems and methods for determining, for the different chosen times, the target draw rate and the resulting safe maximum withdrawal rate.

Individuals may have different time horizons for which they need their funds to survive. In addition, a particular individual may want to compare conservative time horizons against less conservative time horizons. For example, a retiree who is sixty-two years old may want to determine how much he can withdraw for the next 30 years. But, as another possibility, he may feel that a more conservative estimate might be based on a longer mortality and may want to determine how much income he can safely withdraw for the next 40 years. A different individual might need a specific portfolio to last for a shorter time horizon until a mortgage is paid off or a spouse's pension commences. That different individual may want to determine how much income can be safely withdrawn over 5 years or 10 years.

To accommodate these needs, embodiments may modify the analysis of historically successful outcomes to determine multiple target draw rates and their resulting safe maximum withdrawal rates, for a range of different time horizons. An embodiment of that modified analysis repeats the methods described above in reference to FIG. 2A for a range of time horizons as described below.

In one embodiment, a historical analysis of successful outcomes starts with an initial test based on the parameters of an account of $100,000, a typical time horizon of 30 years, and an industry standard withdrawal rate of 5% annually. From that initial account, beginning with a starting date for which 30 years of market data going forward is available, an investment change is either added or subtracted to the account based on the change in value of the underlying portfolio for the first year. Then, the assumed 5% withdrawal rate, or $5,000, is subtracted. These steps may then be repeated for 30 years to arrive at an end value of the portfolio. Subsequent withdrawals over the 30 years may be adjusted for inflation. If the ending balance is below $0, then the test for those particular parameters is considered a downside failure.

The test may then be repeated for each historically testable retirement date. For example, for a 30-year time horizon, if annual data from 1927 to the present day is available, each retirement date from 1927 through to 30 years prior to the present day, may be tested. Likewise, for a 40-year time horizon, each retirement date from 1927 through to 40 years prior to the present day, may be tested.

If historical monthly data is available for an investment (e.g., fund), a similar process could be employed, but based on monthly rates of return and monthly withdrawal amounts. For example, a 5% withdrawal for a $100,000 account would be $416.67 monthly, instead of $5,000 annually.

A traditional withdrawal approach may use the former industry standard 5% withdrawal amount adjusted for inflation. On the other hand, embodiments of the value gap approach may withdraw a value-gap-adjusted safe withdrawal amount, which may be the starting account balance times the target safe withdrawal percent times the multiplicative inverse of the value gap, as described in detail above.

From this initial testing, it was found that using the traditional withdrawal approach an investor could only withdraw a gross annual amount of approximately 3.0% with no downside failures, while the value gap approach could allow withdrawals of 5.3% of the initial account balance with no downside failures. These results were based on the historically available stock market data from 1801 to 2011, using Jeremy Siegel annual data for 1801 to 1871, and Robert Shiller data from 1871 forward. This data was based on the S&P 500.

The 30 year safe withdrawal rates may also be determined for other funds, including value and growth data from Fama-French and large and small stock data from Ibbotson. For example, using 1927 Fama-French annual data, a value blend fund may be constructed from a portfolio of 50% large value stocks and 50% small value stocks. In embodiments, the safe withdrawal rates for that value blend fund were 3.1% of the portfolio price for the traditional withdrawal approach and 7.9% of the initial account balance for the value gap approach.

Based on these tests, to accommodate a range of time horizons, embodiments may provide a target safe maximum withdrawal database, which may be in the form of a target safe maximum withdrawal table. A target safe maximum withdrawal database may, for example, be part of market data database 212 of FIG. 2B. The target safe maximum withdrawal database may be populated by executing historical tests using variations of the initial test parameters. For example, instead of only testing to determine whether the ending balance at year 30 is below zero (i.e., a downside failure), embodiments may execute multiple tests to determine whether the ending balance is below zero at different time horizons, e.g., year 5, year 10, year 15, etc. Any desired increment of time horizon may be used for the multiple tests, such as every year or every 5 years.

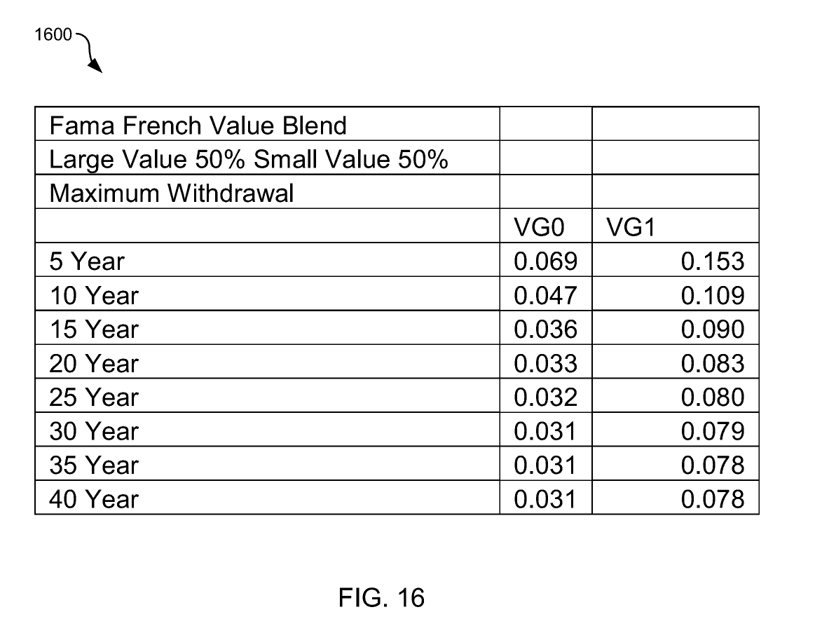

The results of those multiple tests may be used to populate a table of target historically safe maximum withdrawal rates. As one embodiment, FIG. 16 illustrates an example of a table 1600 for a Fama-French Value Blend fund. In that exemplary table 1600, the VG0 column lists target maximum historically safe withdrawal rates (i.e., with no downside failures) for the traditional withdrawal method, while the VG1 column lists target historically safe maximum withdrawal rates (i.e., with no downside failures) for the value gap method.

With table 1600 providing target historically safe maximum withdrawal rates for a range of time horizons (in this example, 5 year through 40 year time horizons, at five year increments), the safe withdrawal amount can be calculated for a given current value gap index of the portfolio and a given time horizon. For example, if a current value gap index is 0.5642 and the time horizon is 30 years, the target safe maximum withdrawal rate (VG1) from the table is 0.079, and a value gap factor would be 0.140026, as calculated by:

Value gap factor=(1/(value gap index))×(target safe maximum withdrawal rate)=(1/0.5642)×(0.079)=0.140026

Thus, in this example, the safe withdrawal amount for 30 years with an account balance of $100,000 would be $14,002.60 annually (0.140026×$100,000=$14,002.60).

The target safe maximum withdrawal rate table 1600 also enables efficient determinations of safe withdrawal amounts for other time horizons. Thus, if the desired time frame is 40 years, the target safe maximum withdrawal rate (VG1) from the table 1600 is 0.078, and a value gap factor is 0.138249, as calculated by:

Value gap factor=(1/0.5642)×(0.078)=0.138249

Thus, in this example, the safe withdrawal amount for 40 years with an account balance of $100,000 would be $13,824.90 annually (0.138249×$100,000=$13,824.90).

In addition to varying the increments of time horizons, a target safe maximum withdrawal database may include target safe maximum withdrawal rates for different starting account balances, e.g., accounting balances other than the $100,000 described in the above examples. This additional data may enable a user to designate different starting account balances and compare safe withdrawal amounts for each starting account balance.

In embodiments, a target safe maximum withdrawal database may also accommodate varying investment goals that different individuals may have, such as a risk tolerance or a desired ongoing account balance. For example, as an example of risk tolerance, embodiments may determine historically safe maximum withdrawal rates based on different parameters of historical success. In examples described above, target safe maximum withdrawal rates may be based on 100% historical success, meaning no downside failures. In an alternative embodiment, maximum withdrawal rates may be based on a different percentage of historical success, such as 90%, meaning that at least 90% of the outcomes did not have a downside failure.

As another example of accommodating varying investment goals, other embodiments may determine target historically safe maximum withdrawal amounts based on different desired ending values of an account. For example, one embodiment may determine the most that can be withdrawn while still maintaining the starting account value. Thus, if a starting account balance is $100,000, the target safe maximum withdrawal amounts would be based on an ending value of $100,000. Other embodiments may accommodate any desired ending value. As another example, embodiments may account for the effects of inflation on the ending value, and may determine the most that can be withdrawn while still maintaining the starting account value, adjusted for inflation. The inflation adjustments may be made based on the Consumer Price Index (CPI).

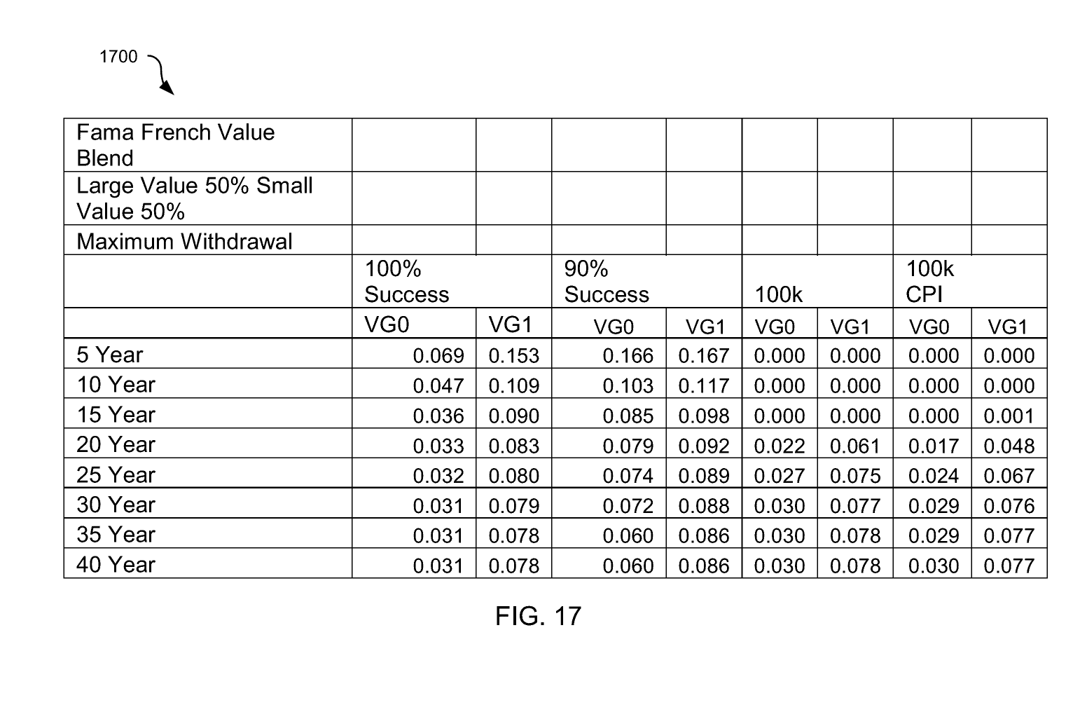

FIG. 17 illustrates an embodiment of a target safe maximum withdrawal rate table 1700 for accommodating the various goals and risk tolerances described above. As with FIG. 16, the table 1700 of FIG. 17 is for a Fama-French Value Blend fund. As shown in table 1700, target safe maximum withdrawal rates for the traditional approach (VG0) and value gap approach (VG1) are provided for 100% success (no downside failures), for 90% success (at least 90% of the outcomes did not have downside failures), for 100% success that maintains the starting account value of $100,000 (labeled 100 k in the table of FIG. 17), and for 100% success that maintains the starting account value of $100,000 adjusted for inflation (labeled 100 k CPI in the table of FIG. 17).

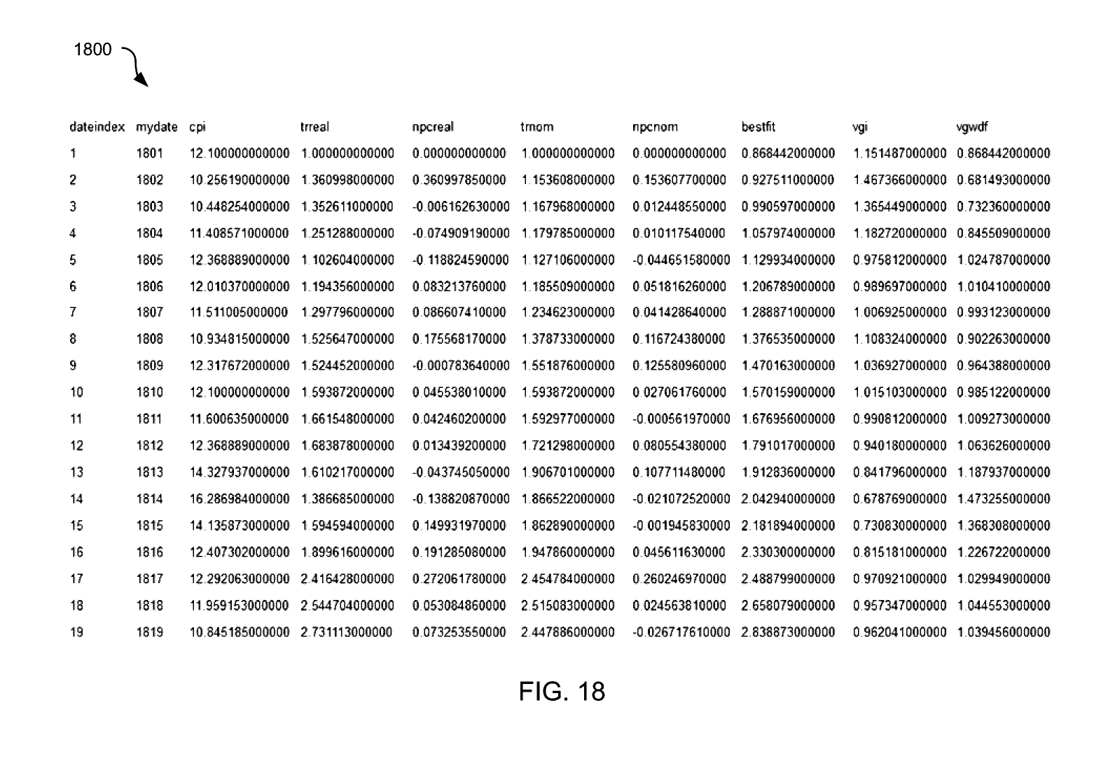

A target safe maximum withdrawal database may be constructed using web applications, computer programming languages, and database software, such as PHP for script and MySQL for the database. In an embodiment, to create a target safe maximum withdrawal table, a database of historical values is constructed. As shown in the table 1800 of FIG. 18, an exemplary database may include the following data fields:

date index—provides a means to refer to a specific row in the program;

my date—the date being tested or referred to in the program;

cpi—the Consumer Price Index, which may be used to adjust the withdrawals for inflation;

trreal—total real return of the portfolio;

npereal—net real price change, which is the rate of return from the current year compared to the prior year;

trnom—total nominal return, which is the total return of the portfolio, without being adjusted for inflation;

npcnom—net price change nominal, which may be used to increase or decrease the value of the account;

bestfit—the value of the trend line, described above in determining the internal value;

vgi—value gap index at a specified time; and

vgwdf—the inverse of the value gap index, by which the withdrawal may be multiplied to calculate the value gap withdrawal;

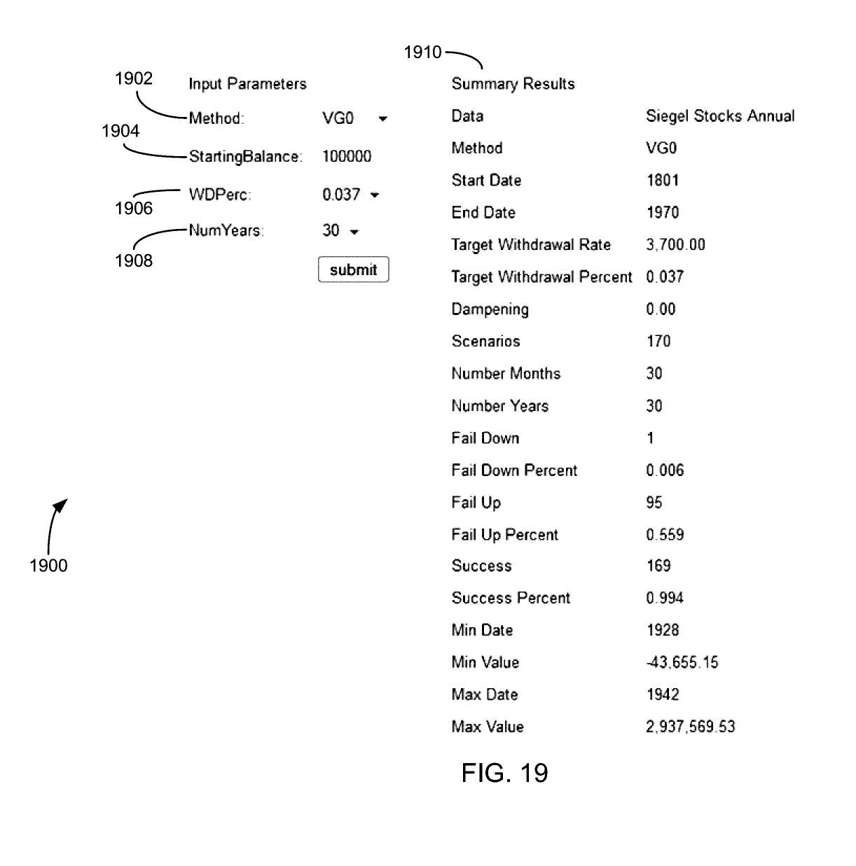

To calculate a safe withdrawal amount using a target safe maximum withdrawal table, the additional calculation parameters may be obtained from user input. This input may be provided, for example, through a user interface 206 as shown in FIG. 2B. As one embodiment, FIG. 19 illustrates an exemplary user interface form 1900 for collecting from a user designated parameters to be tested. As shown, input fields may include:

Method 1902—designating whether to test the traditional withdrawal approach (VG0), the value gap withdrawal approach (VG1), or the value gap withdrawal approach with step-ups (VGSU);

Starting Balance 1904—the starting balance of the account;

WDPerc 1906—the withdrawal percentage to be tested, which may be, for example, a drop-down list of possible values from 0 to 20%; and

NumYears 1908—the time period to be tested, which may range, for example, from 5 to 40 years.

Using this input data and a target safe maximum withdrawal table, an embodiment may provide output 1910 as shown in FIG. 19. This output 1910 may be provided, for example, through a user interface 206 as shown in FIG. 2B. Once the user selects the method 1902, starting balance 1904, withdrawal percentage 1906, and number of years 1908, a computer program may then execute the historical analysis as described above or may retrieve data of already-executed historical analyses, and then display output 1910 showing whether the test was a failure or success. A failure may be defined as a result with an ending balance below zero. The program may be adjusted to test for a threshold amount other than zero or to test for a percentage of success other than 100%, as described above.

As shown in FIG. 19, the output 1910 may include feedback information such as the data set that was used (e.g., Siegel Stocks Annual), the method that was used (e.g., VG0), the start date and end date that was tested (e.g., 1801 and 1970, respectively), the target withdrawal amount and target withdrawal percent (e.g., $3,700.00 and 0.037, respectively), the dampening factor which shows a 1 if value gap was applied and a 0 if no value gap was applied, the number of scenarios that were tested (e.g., 170), and the time frame of years or months that were tested (e.g., 30 years).

Based on that feedback information, the results 1910 may then further show the outcome of the test, including the number of up failures and the percent of up failures (e.g., 95 and 0.559, respectively, with the percent of up failures calculated as the number of up failures divided by the number of scenarios, or 95/170), the number of downside failures and the percent of downside failures (e.g., 1 and 0.006, respectively, with the percent of downside failures calculated as the number of downside failures divided by the number of scenarios, or 1/170), and the number of successes and the percent of successes (e.g., 169 and 0.994, respectively, with the percent of successes calculated as the number of successes divided by the number of scenarios, or 169/170). If further analysis is to be done, the output 1910 may also include the maximum value and what date had the maximum value (e.g., 2,937,569.53 and 1942, respectively) and the minimum value and what date had the minimum value (e.g., −43,655.15 and 1928, respectively).

To fully populate a target historically safe maximum withdrawal database, embodiments may provide systems and methods for determining a withdrawal rate that achieves the desired historical success. Embodiments may provide computer hardware and/or software that iteratively loop through each annual starting date for a particular time horizon, such as 30 years. The calculations may be modified by the input parameters. The ending of the loop would end as designated by the input NumYears 1908, e.g., 5 years or 40 years. The account balance would change each year based on the prior year's account balance, the nominal price change of the portfolio, the target withdrawal percent 1906, the current year's CPI factor, and the method 1902, whether traditional, value gap, or value gap inflation adjusted.

Alternative embodiments may iteratively run through monthly starting dates for a particular time horizon, rather than annual starting dates. In this case, the number of years would change to number of months. Other intervals of starting dates may be possible, such as quarterly starting dates.

Referring to FIG. 19, the number of scenarios of the output 1910 corresponds to the number of starting dates over the period of available data, which in this example is 170 scenarios corresponding to 170 annual starting dates from the start date of 1801 to the end date of 1970. For each of those scenarios, embodiments may conduct a test with a target safe maximum withdrawal software program for each time frame and each withdrawal method (e.g., traditional (VG0), value gap adjusted (VG1), or value gap adjusted with step ups (VGSU)). An initial withdrawal amount may be tested for a given time frame and method. If the result is a success, then the withdrawal percentage is increased and the test is repeated. The test is repeated with increasing withdrawal percentages until an outcome shows a failure. Then the withdrawal percentage is decreased to the last amount that was a success. Optionally, instead of receiving a target withdrawal percent 1906 from a user, a computer program may automatically calculate an estimate of, or randomly choose, a target withdrawal percent and iteratively run the tests to determine a target safe withdrawal percentage.

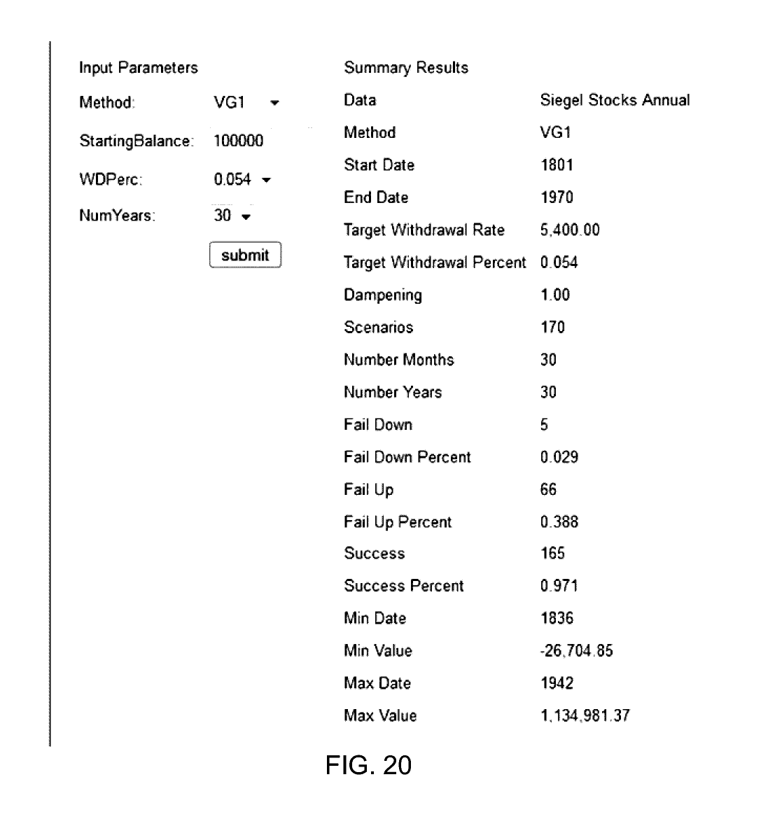

FIG. 20 illustrates an example of a test of a value gap method (VG1) with a starting balance of $100,000 and a user-designated 5.4% withdrawal rate for 30 years, which results in 5 downside failures and a 2.9% downside failure percentage (i.e., 5 failures out of 170 scenarios).

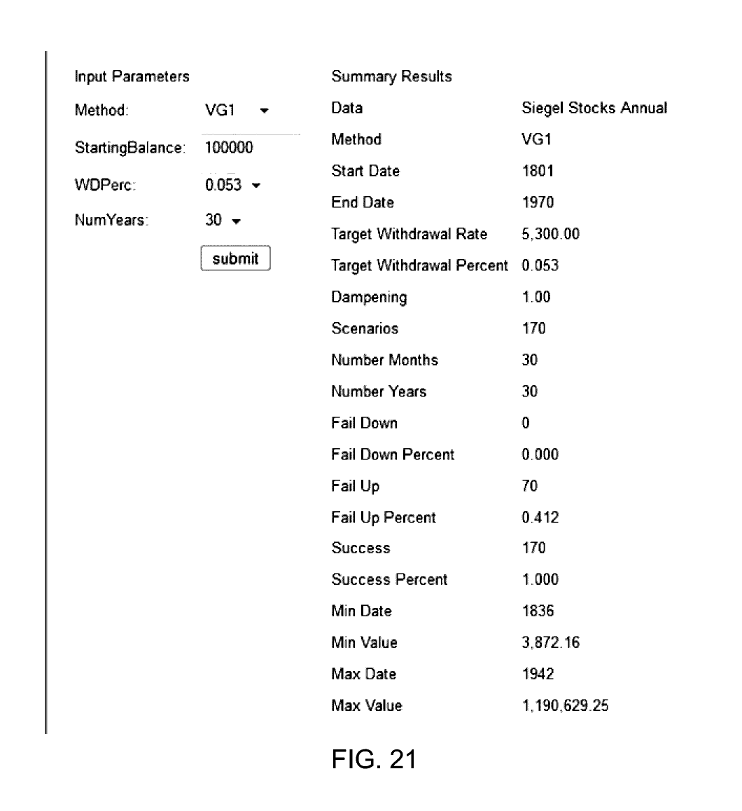

In contrast, FIG. 21 illustrates an example with no downside failures. As shown, in this example, using a value gap method (VG1) with a starting balance of $100,000 and a 5.3% withdrawal rate for 30 years, the output indicates zero downside failures and a 0.0% downside failure percentage. Thus, in the example of FIGS. 20 and 21, the maximum historically safe withdrawal rate for the value gap method with a starting balance of $100,000 would be the highest withdrawal rate that results in no downside failures, which is 5.3% as shown in FIG. 21.

Implementations of the present embodiments may use computer software programs including Microsoft Excel™ with Visual Basic™ and web applications based on Microsoft Access™ and PHP.

Once a target historically safe maximum withdrawal database is established, further embodiments may provide systems and methods for managing and updating the database and other databases necessary for calculation of safe withdrawal amounts, for accessing and manipulating data of the databases, and for calculating and providing safe withdrawal amounts based on the data. To provide those functions, embodiments may provide a computer graphical user interface, for example through a web application, and associated software program(s). In an embodiment, a web application and/or associated software program(s) may have three aspects: (1) database management; (2) user interface; and (3) programming and calculations. In one implementation, the systems and methods for providing safe withdrawal amounts use PHP scripts and a MySQL database, although any combination of programming languages and databases may be used.

In supporting database management, embodiments may provide a database table to capture current fund values. The fields in the fund value database table may include the fund name, the data entry date, the fund amount on the data entry date, and a database ID (identification) to allow for updating or correcting information.

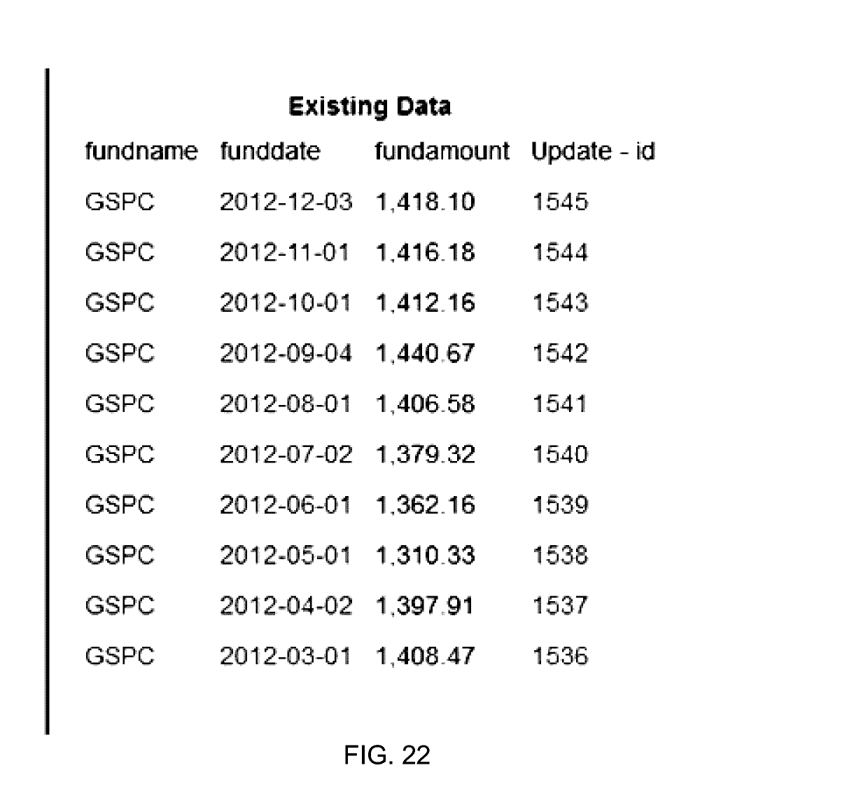

As an example, FIG. 22 illustrates a fund value database table for the fund designated as GSPC, with fund amounts entered monthly from Mar. 3, 2012 through Dec. 3, 2012.

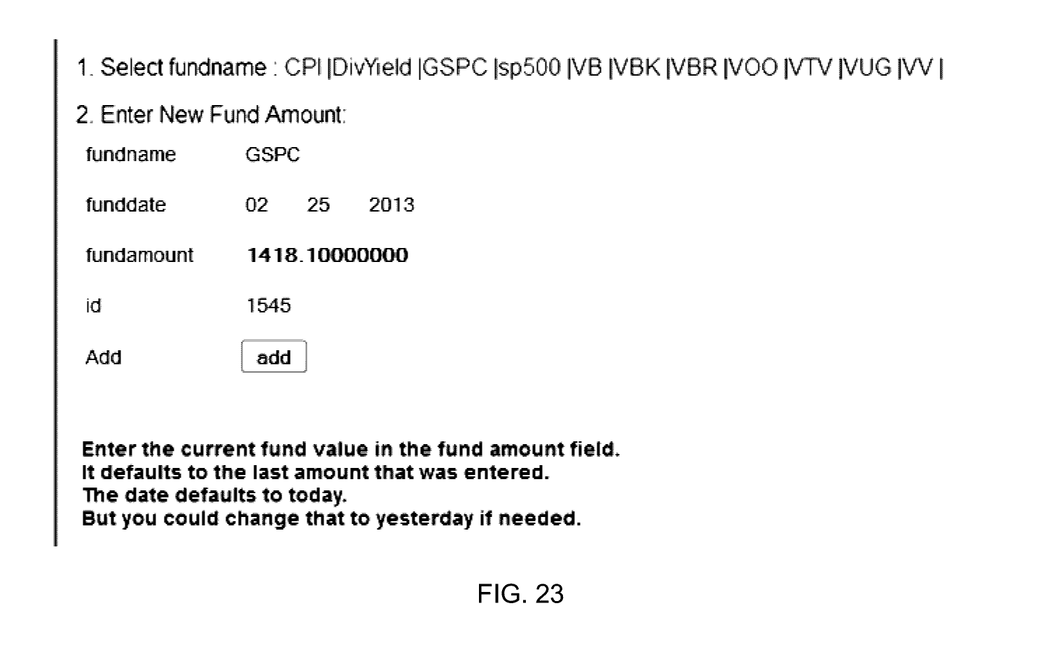

As shown in the exemplary user interface of FIG. 23, an administrator of the database may enter current values on a monthly, weekly, or daily basis, or some other desired interval of time. The administrator may select the fund they are updating, obtain the fund value from an online resource, and enter current date and the current index value of that fund. In alternative embodiments, market data providers, such as market data providers 204 shown in FIG. 2B, may automatically provide fund data so that the database is automatically updated with ongoing fund values at desired intervals.

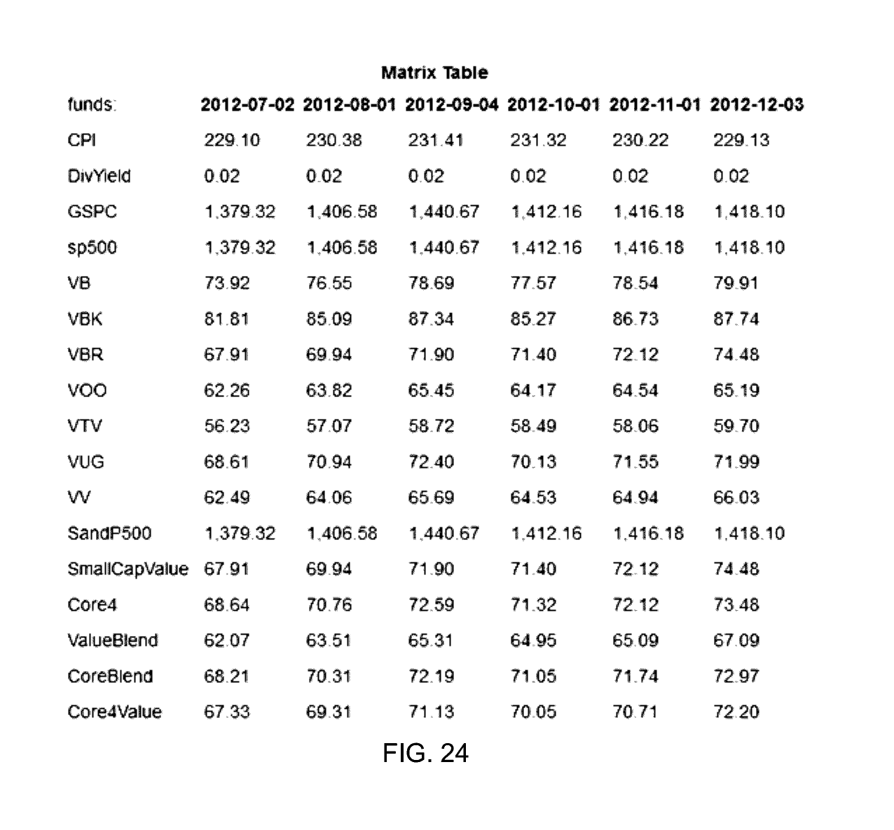

In some embodiments, several funds may be tracked and updated with fund amounts at desired intervals of time. A summary may be provided to show which funds are up to date, and which are not. As an example, FIG. 24 illustrates a fund value summary database table for several different funds, showing monthly value updates for the funds from Jul. 2, 2012 through Dec. 3, 2012. In addition to funds (e.g., mutual funds or ETFs), other data needed for safe withdrawal amount calculation may be tracked, such as the Consumer Price Index and Dividend Yields rows shown in the table of FIG. 24.

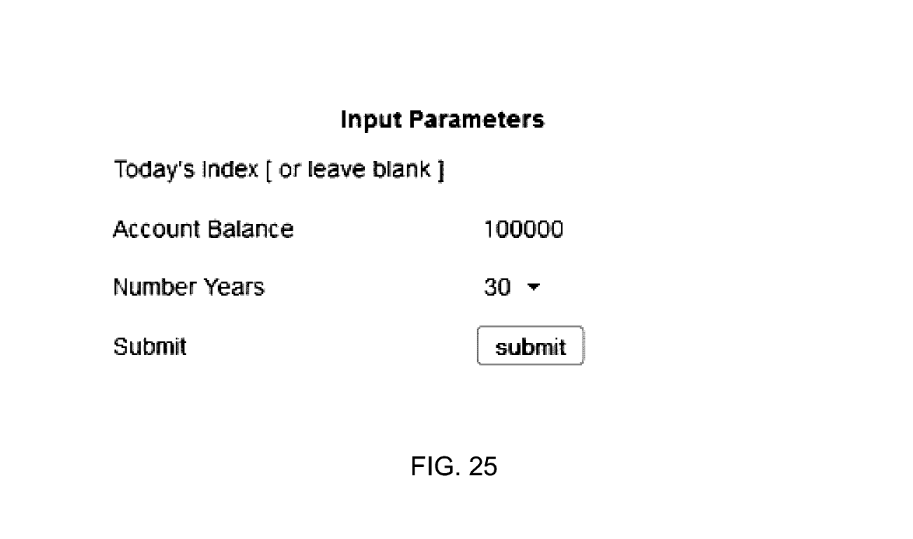

Turning now to the user interface, embodiments may provide computer graphical user interfaces and associated software programs that receive input from users and display results of the safe withdrawal amount computations. In embodiments, a user interface may prompt a user to enter parameters used for the computations. For example, a user may select a desired portfolio. A different web page may be constructed for each portfolio or a menu item on a form could be provided, from which the user selects a desired portfolio. Then the user may enter the account balance and the number of years. Optionally, a user could enter the current value of the fund. If the user does not enter a current value, the latest value from a database or a market data provider may be used. As an example, FIG. 25 illustrates an exemplary graphical user interface through which a user may enter parameters including the current index value of the fund, the starting account balance, and the number of years (i.e., time horizon).

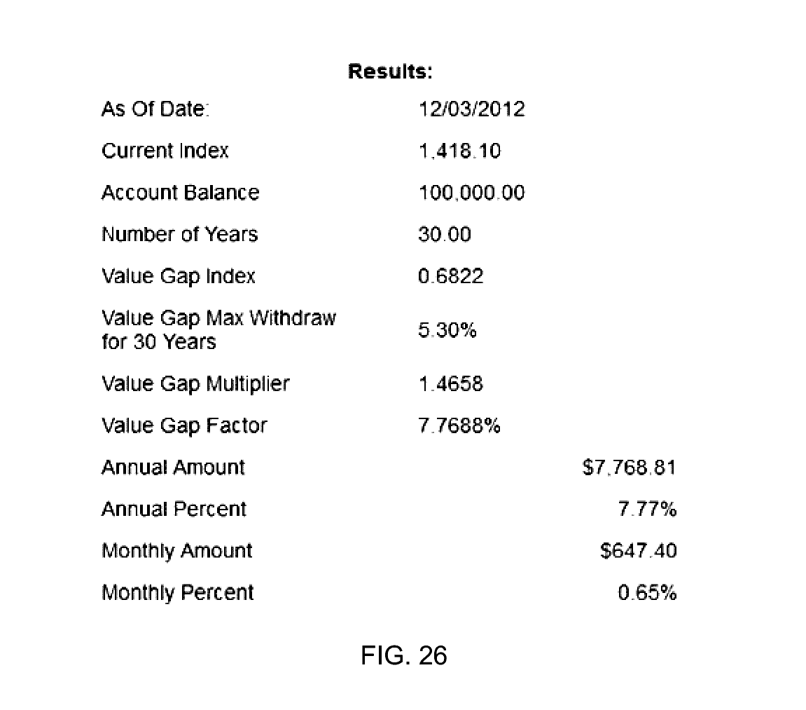

Based on the input parameters, embodiments calculate the safe withdrawal amount as described above and display the results. As shown in the exemplary screen image of FIG. 26, that output may include the following:

a summary of the input parameters that the user entered, such as the account balance and the number of years;

the fund's current value and the date of that value;

the value gap index, as determined by dividing the fund's real total return by the trend line (indicating internal value) as described above;

the value gap maximum withdrawal rate, or target safe withdrawal rate, which may be retrieved from a target historically safe maximum withdrawal table based on the number of years selected;

the value gap multiplier, which is the multiplicative inverse of the value gap index; and

the value gap factor, which is the value gap max withdrawal (or target safe withdrawal) times the value gap multiplier.

As further shown in the exemplary screen image of FIG. 26, the output may also provide the actual withdrawal amount in annual and monthly terms based on the starting account balance. Thus, in this example, since the value gap factor is 7.7688%, the annual safe withdrawal amount based on a starting account balance of $100,000 is $7,768.81.

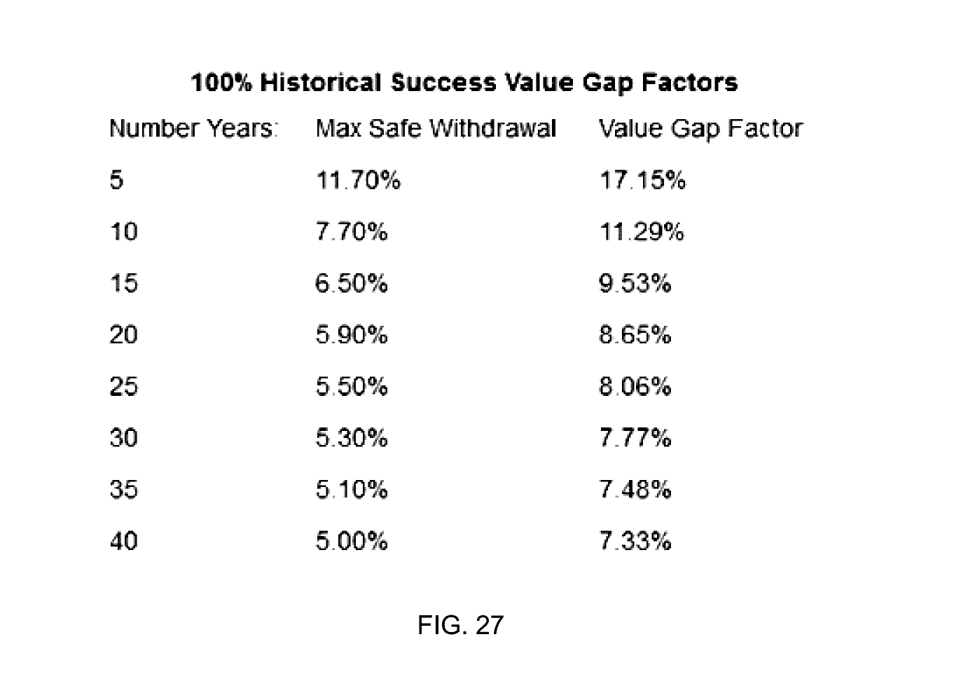

Embodiments may also provide an output that includes the target safe withdrawal rates and value gap factors for other time horizons, as shown in FIG. 27.

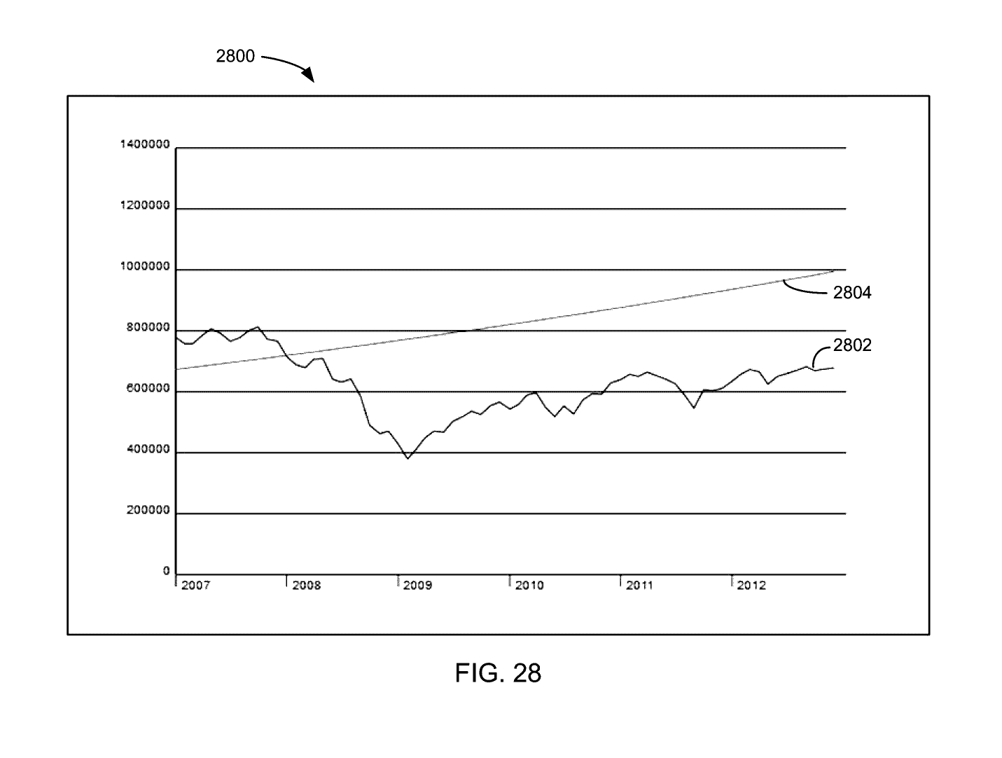

Other outputs could be provided. For example, as shown in FIG. 28, a linear chart 2800 showing the relationship between the current total return line 2802 and the trend, or best fit, line 2804 may be provided to illustrate how the value gap index is trending.

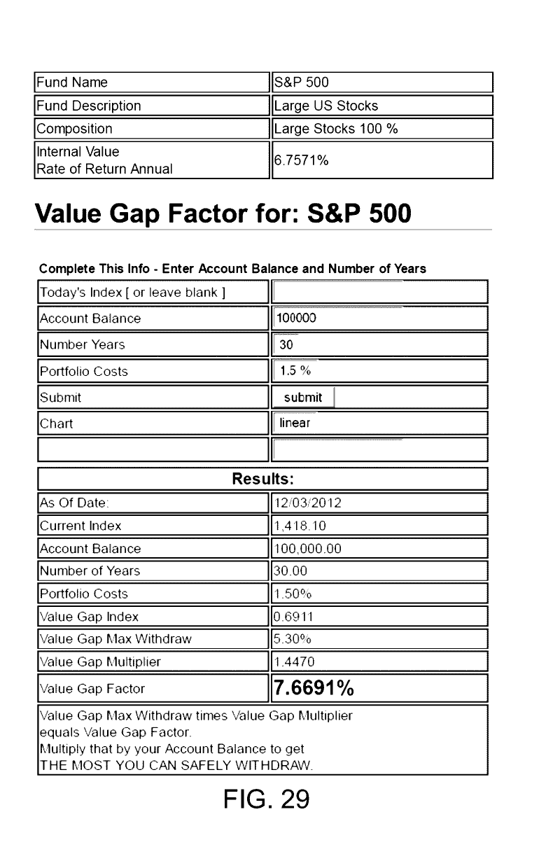

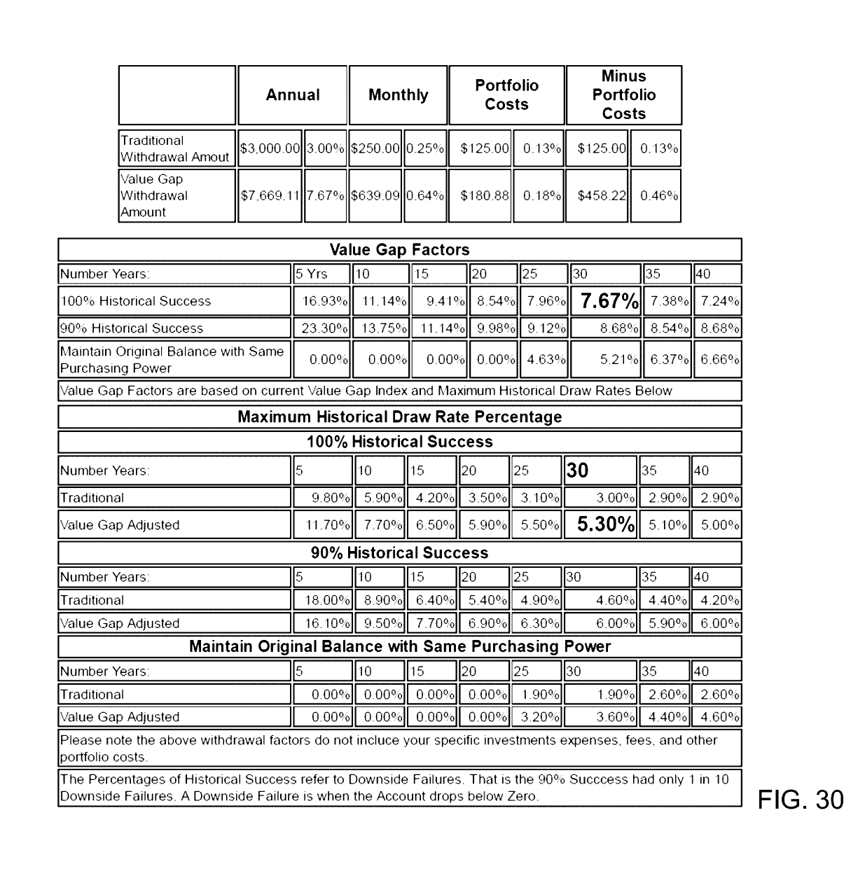

FIGS. 29-31 illustrate additional embodiments of results provided on a computer graphical user interface. As shown, the results are based on user-provided parameters including an S&P 500 fund, a starting account balance of $100,000, and a time horizon of 30 years. These embodiments also factor in estimated portfolio costs, which the user has designated as 1.5% in this example. As shown in FIGS. 29-30, the results may include the value gap factor and related information as described above in reference to FIG. 26.

Specifically, in this example, as shown in FIG. 29, the value gap factor is 7.6691%, which is equal to the value gap max withdrawal (target safe maximum withdrawal) of 5.3% times the value gap multiplier of 1.4470. Multiplying the starting account balance of $100,000 by the value gap factor of 7.6691% determines the safe withdrawal amount, which is $7,669.11 annually as shown in FIG. 30. As further shown in FIG. 30, the results may also include the safe withdrawal amount as a monthly withdrawal amount ($639.00), may show the monthly portfolio costs ($180.88) as provided by user input, and may show the final monthly withdrawal amount ($458.22) after the portfolio costs have been deducted. For comparison purposes, the results may also show the traditional withdrawal amount (e.g., 3% annually).

Embodiments may provide even more extensive results as shown in FIG. 30, including value gap factors and maximum historical draw rate percentages (target safe maximum withdrawal percentages) for a range of time horizons (e.g., 5 years to 40 years) and for different goals and risk tolerances as described above (e.g., 100% historical success, 90% historical success, and 100% historical success while maintaining the original account balance with the same purchasing power).

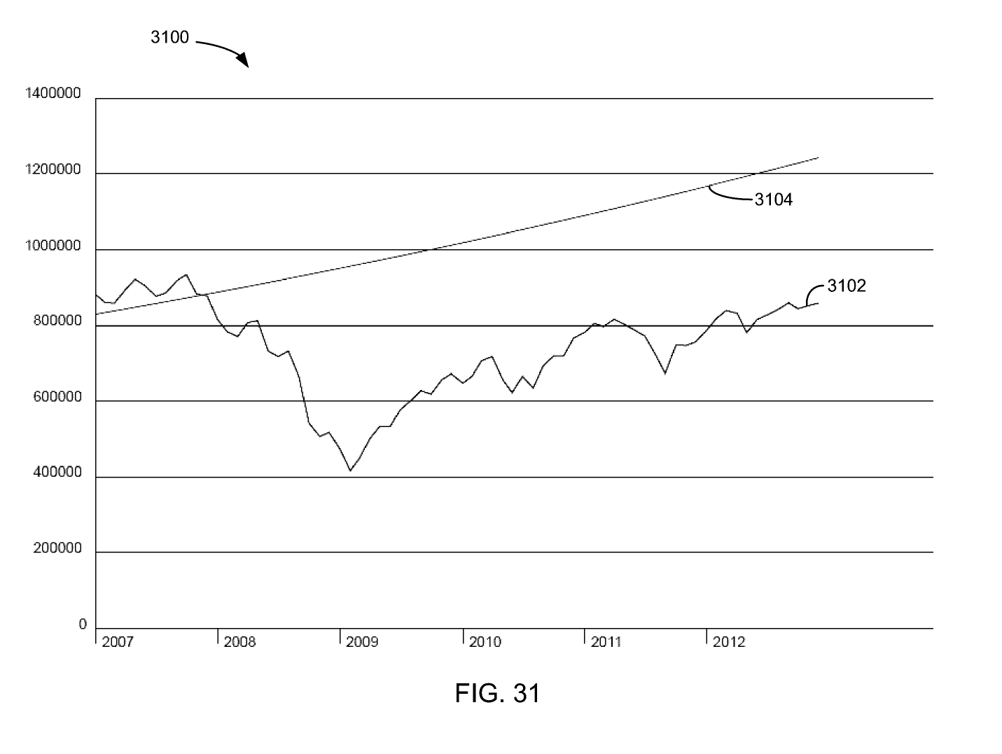

As shown in FIG. 31, in embodiments, the results may include a chart 3100 illustrating the trend line 3104 (internal value) and actual returns 3102 of the fund over a designated number of past years, such as 5 years.

To provide results such as those shown in FIGS. 26-31, embodiments may provide systems and methods for retrieving the parameter data, e.g., from user input or databases, and calculating and displaying the results. In embodiments, a computer software program pulls data submitted by a user on a web application form and retrieves the necessary fund data from a database or market source provider. With this data, embodiments provide methods and systems for calculating safe maximum withdrawal amounts and displaying the associated results.

In an embodiment, a first step establishes a starting date from which the analysis is projected forward. That starting date establishes the baseline values for data such as Consumer Price Index, and is the date based on which real total return, best fit (e.g., trend line), and other calculations are performed.

Next, the value gap index may be calculated by dividing the real total return by the best fit line (e.g., trend line). The real total return may be calculated from nominal index values obtained, for example, from values periodically entered into a fund database as described above, or from values supplied by a market data provider. To convert from nominal to real index values, an embodiment multiplies the nominal value by a CPI factor. A CPI factor may be the CPI as of the starting date (designated in the first step) divided by the current month's CPI. If the fund includes dividends, a dividend yield may be added for each month from the starting date.

A best fit line, or trend line, may be based on a logarithmic regression that creates a y-intercept and slope. To calculate the current best fit line, the following formula may be used:

Best Fit=(y-intercept)×(slopêlog row)

In one example, log row is the number of years or months from the initial data set. Accordingly, a calculation of the date differential between the starting date and the current date may be performed. Although the calculation may result in a decimal, the calculation may still be sufficiently accurate for purposes of determining best fit.

For example, the log row for a baseline might be 211 if 211 years of data are available from 1801 to 2011. At the end of 2012, the log row would become 212. In June of 2012, it would be around 212.5

Once the current real total return and current best fit line are determined, the current value gap index may be determined by dividing the total return by the best fit (i.e., (total return)/(best fit)).

To provide programming efficiencies, embodiments may store data, such as y-intercept, slope, total return, and log row, as variables. In addition, to efficiently determine a value gap factor, embodiments may provide an array of values for the target safe maximum withdrawal. In this manner, for example, if a user selects 10 years, the target safe maximum withdrawal percentage for 10 years may be quickly selected.

Embodiments may also provide a linear chart of the total return and best fit, such as the exemplary chart shown in FIG. 31. To produce a linear chart, these embodiments may translate the years or months into x-values and translate the total return and best fit values into y-values. The resulting x- and y-values may then be rendered in Scalable Vector Graphics (SVG), Adobe Flash™, or another suitable visual display, showing a linear plot of the x- and y-values.

Referring to FIGS. 29-30 for example, alternative embodiments may provide additional results related to specific commercial implementations of determining safe maximum withdrawal amounts. For example, as discussed above in reference to FIGS. 13-15, a safe maximum withdrawal amount may be used not only for income for the investor, but may also cover other expenses such as insurance premiums and other fees associated with a variable annuity product and a guaranteed minimum withdrawal benefit. Displayed results may therefore indicate the apportioning of a value gap factor and a value gap safe withdrawal amount to the different categories of income and expenses. This apportioning may be calculated as a certain percentage for each category. For example, in FIG. 29, the value gap factor of 7.67% and value gap safe withdrawal amount of $7,669.11 may be broken down and shown in an additional display as 6% for income for the investor ($6,000), 1% for an insurance premium and guaranteed minimum withdrawal benefit ($1,000), and 0.67% for other fees ($670). These additional results may be beneficial for financial advisors who determine safe withdrawal amounts on behalf of their investor clients and secure appropriate insurance and guaranteed minimum withdrawal benefits for those clients.

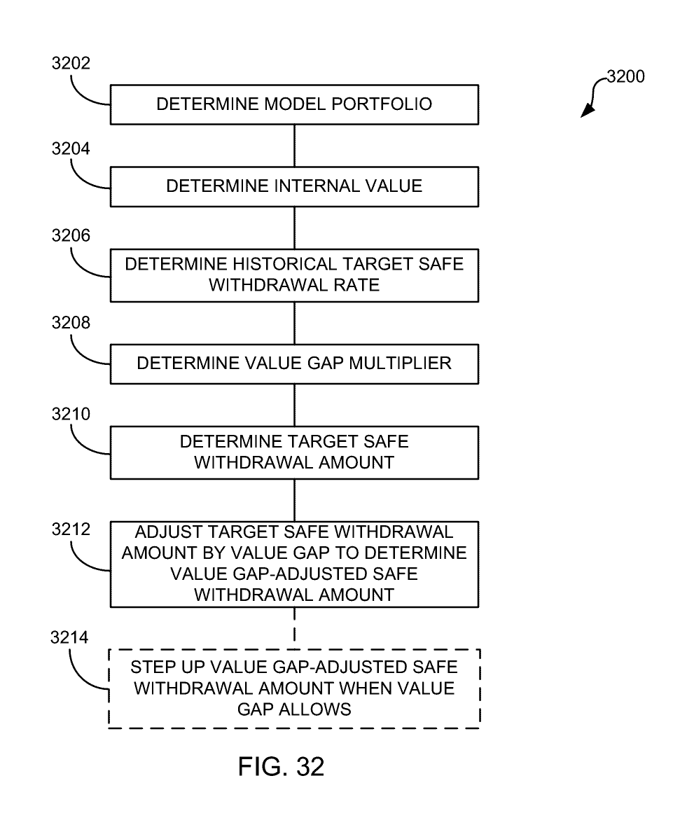

Additional embodiments provide methods and systems for creating a portfolio based on market indices or model portfolios, or comparing an existing portfolio to market indices or model portfolios, and determining an investment portfolio withdrawal rate based on the market indices or model portfolios. Along these lines, FIG. 32 illustrates an exemplary value gap method 3200 for determining an investment portfolio withdrawal rate.

As shown, method 3200 begins in step 3202 by determining an appropriate model portfolio. To apply the value gap method, a model portfolio may be selected that is identical or very similar to an investor's actual portfolio. The model portfolio may be used as a basis for the internal value that will be used to calculate income, and from which to compare the current portfolio price. The model portfolio provides a source for the past historical data used for the computations. The model portfolio may be a portfolio of equities for which significantly long historical data is available, preferably dating back at least before the Great Depression.

If long historical data is not available for an investor's actual portfolio, one may select a model portfolio that is anticipated to correlate well with some existing model with long historical pricing and dividend data where one would expect price movements to track closely enough with the model portfolio. This could be a single portfolio or several different ones blended together and periodically rebalanced, so they could be viewed collectively as one portfolio. In addition, although this process is not limited to equity portfolios, significant expected earnings over and above the expected rate of inflation are preferred, and equities are the only asset class that has done that consistently over retirement length periods for centuries and through all economic seasons.

For a portfolio to be viable in this process, it may be diversified broadly enough and consistent enough in its methodology to achieve validity from a value gap sense. This can be tested by performing a qualitative check in which the long-term data is plotted on a log scale, such as in total return lines described above. If the shape over time does not trace around a consistent trend upwards, then something may be amiss in diversification, portfolio methodology, or time frame, which may invalidate a chosen portfolio for this purpose. If, for example, a total return line does not indicate many years of performance trending on the same track, then the chosen portfolio may not be appropriate for the value gap approach.

With the model portfolio determined, method 3200 continues in step 3204 by determining the internal value. In an embodiment, the data of the selected portfolio, such as historical price, dividend, and inflation data, is obtained in a form called real total return, as described above. The purpose of this real total return data is to extract the actual, raw investment performance over time. Thus, in embodiments, data may be adjusted to include dividends being reinvested, which may provide the “total” return. In further embodiments, the effects of inflation may also be normalized out. When inflation is left in, it may be referred to as “nominal” return, and when it is normalized out, it may be referred to as “real” return. With dividends reinvested and inflation taken out, the data may then be in the form of “real total return.”

With the real total return data plotted over many years, the internal value may be determined by smoothing out the data to a mathematical mean. As described above, in one embodiment, a logarithmic regression analysis may be performed. Other ways to define a historic internal value line are possible. Accordingly, notwithstanding the benefits of using logarithmic regression analysis, embodiments should be considered broadly applicable to any method that adequately estimates the trend around which price data is tracking and reverting to over a significantly long period.

Embodiments use longer term analyses, e.g., including roughly three human generations of history, and at least the year 1929 event, which may provide more trustable results. In embodiments, portfolios may be some form of long-calculated index, even if that index portfolio was created more recently, just so long as the data was extracted in a legitimate and repeatable way. While the holdings in an index may change over time, the methodology, continuity, and diversification of the index should preferably be consistent enough to show what is needed to establish a worthwhile estimate of the true internal value.

In embodiments, logarithmic regression analysis may be performed on spreadsheet software, such as Excel™. Entering real total return data into the spreadsheet software may yield two pieces of output: slope and y-intercept. The variables are two constants in the formula for an exponential line that may then be used for creating a second column of data in the spreadsheet that runs beside the original data. The spreadsheet software may use the formula y=ab̂x where “a” is the y-intercept and “b” is the slope. When graphed, the data may result in an exponential curve that is effectively the original data all smoothed out, appearing on the log graph as a straight line. The straight internal value line may be superimposed on a graph with the real total return line, such as is shown in FIG. 1A.

With the internal value determined, method 3200 continues in step 3206 by determining a historical target draw rate. The target draw rate may represent the percentage that is believed can be safely drawn over some period of future time. As described above, the target draw rate may involve back-testing to determine what has happened historically and what has worked through all past extremes. Using historical, rolling return periods (as described above), embodiments may test what would have worked for every period in the history of the data and may solve for the highest target rate that resulted in no failures. Alternative embodiments may solve for any other scenario, e.g., 90% successful outcomes or a rate that resulted in no less than 50% residual value from the starting amount. Other embodiments may solve for longer or shorter time periods. For instance, a 90-year old investor may want to determine a target draw rate based on 10-year or 15-year success rates.

In embodiments, a target draw rate is determined based on zero downside failures across all past 30-year periods for which data is available. Other parameters may be used, and spreadsheet software may be used to test the other parameters. In embodiments, determining the target draw rate may involve calculating the ending values for all rolling periods, and may analyze what happens for all 30-year windows, raising or lowering the tested draw rate until reaching a maximum rate that results in no downside failures, as described above.

In embodiments, historical testing has yielded a target safe draw rate (no downside failures) of 5.3% for all-U.S. Equity portfolio for the last 200+ years, which may represent a realistic retirement scenario. Interestingly, the Great Depression Era event was not the defining factor in this case. The 5.3% maximum was defined around starting points prior to the Civil War, notably around 1836. If the testing had not gone back to include this period, the maximum target safe rate would have been 5.6% as defined by the cycle in the late 1920s and early 1930s.

In alternative embodiments, the target safe draw may be considered a gross draw, and additional real world costs are accounted for by subtracting them from the target safe draw rate to determine net pre-tax withdrawal amounts.

With the target safe draw rate determined, as shown in FIG. 32, method 3200 continues in step 3208 by determining the current value gap multiplier. The difference between the price of the model portfolio and the internal value on any given date may be referred to as the value gap. The value gap index (e.g., (total return)/(trend line), where the trend line represents internal value) and value gap multiplier (e.g., 1/(value gap index)) may represent that proportional difference. As described above, the value gap multiplier may be used to determine the value gap factor, which then may be multiplied by the balance of the portfolio to determine the safe withdrawal amount, or value gap-adjusted withdrawal amount.

In an embodiment, a value gap multiplier may be determined by dividing the internal value at present by the model portfolio price. If the portfolio price is higher than the internal value, then the portfolio may be considered overpriced and the starting withdrawal may be adjusted down to avoid taking too much and running the portfolio out early.

For example, if internal value is $88,933 and model portfolio price is $116,054, then the value gap multiplier is ($88,933/$116,054)=0.766. With this value gap multiplier being less than 1, a reduced withdrawal amount results, in comparison to a dangerously high withdrawal amount that may have otherwise been used without the value gap multiplier.

On the other hand, if a model portfolio price is below the internal value, a value gap multiplier will be greater than 1, indicating a portfolio that is underpriced and a higher withdrawal amount that could be taken. For example, if the model portfolio price is $67,098 for the same internal value of $88,933, the value gap multiplier is ($88,933/$67,098)=1.325.

Having determined the value gap multiplier, as shown in FIG. 32, method 3200 continues in step 3210 by calculating a target safe withdrawal amount based on the target safe withdrawal rate determined in step 3206, which may then be adjusted using the value gap multiplier to determine an actual starting safe withdrawal amount. In an embodiment, the target safe withdrawal rate is multiplied by the current balance of the actual portfolio. For example, for a portfolio invested in holdings that mimic the Standard and Poor's 500 Index (which would be the proxy for U.S. stocks) having a balance of $680,435 and target safe draw rate of 5%, the calculated annual target safe withdrawal amount would be 5% of $680,435, or $680,435×0.05=$34,021. This annual target safe withdrawal amount may be divided by 12 to determine the monthly target safe withdrawal amount: $34,021/12=$2,835.

Having determined the target safe withdrawal amount based on the target safe withdrawal rate, method 3200 continues in step 3212 by adjusting the target safe withdrawal amount by the value gap to determine the value gap-adjusted safe withdrawal amount. Thus, in an embodiment, to calculate a first paycheck, the value gap multiplier of step 3208 is multiplied by the target safe withdrawal amount of step 3210. For example, if the value gap multiplier is 1.325 and the monthly target withdrawal amount is $2,835, then the value gap-adjusted starting monthly paycheck would be: $2,835×1.325=$3,756 per month.

In further embodiments, going forward, the value gap-adjusted safe withdrawal amount may be adjusted periodically (e.g., yearly, quarterly, or monthly) by the applicable CPI-U inflation factor for the period. For example, if inflation had been 3.2% for the year, then the monthly paycheck may be multiplied by 1.032, resulting in a $3,877 monthly paycheck for the next year. In this way, purchasing power may remain relatively constant and an investor may essentially maintain a constant standard of living.

As shown in FIG. 32, method 3200 may optionally continue in step 3214 by determining a step up. For example, assuming that target safe draw rate was calculated to result in zero downside failures, and assuming prices are rising, an investor's income may rise over time, which may maintain the same standard of living. In embodiments, when desired, the preceding steps of method 3200 may be repeated, and if the result of a repeated calculation is a larger paycheck, an investor may increase the paycheck to that larger amount. If the result is lower, the investor does not reduce the income. This step up may be possible if the maximum target safe draw rate was set to solve for zero downside failures. If, however, maximum target safe draw rate is based on other criteria that have more restrictive thresholds than zero downside failures, the step up feature may not apply.

Implementations of the Present Embodiments

Embodiments of methods and systems for value adjusted income planning, or the value gap approach, may have broad applicability to the investment industry, for example, by improving the way that investors of all types approach their investment and income decisions.

In particular, embodiments may be especially useful for the Deferred Variable Annuity industry. In 2011, the insurance companies that make up the Deferred Variable Annuity industry received over a hundred and fifty five billion dollars in new inflows to their Variable Annuity products. Most of this inflow was to products that offer forms of income insurance. For an additional fee, these products offer replacement income in the event that a portfolio depletes during the investor's lifetime or joint lifetime with a spouse. With these products a person can effectively make an IRA into what the inventor refers to as a JRA (Joint Retirement Account).

These accounts allow the investor to utilize a diversified and flexible investment portfolio, to keep ownership of the assets and potentially pass them along to heirs—assuming the outcome is favorable and the accounts survive the needed retirement income. In the event that the accounts deplete during the investor's lifetime, the income is then often guaranteed for the entire life of either surviving spouse in the form of a monthly paycheck funded by the insurance company despite there being no money left in the account.

To qualify for this back up paycheck, the investors work within certain restrictions about how much income they take each year and at what age they start taking it. It is an elegant solution that in most investors can understand. The investor is effectively trading off some upside in the form of a higher fee, for a safety net that replaces the income if the portfolio runs out during the lifetime of either spouse.

Unfortunately, because of the real world challenges now faced by these insurance companies (persistent low interest rate environment, unconstrained cost of hedging the guarantees vs. the fixed contract fees on the products, issues of risk balancing their product lines, and capacity constraints to cover front loaded costs of paying selling agents), these products are becoming extinct. As a result, the insurance companies have been replacing their products with newer ones that are increasingly more watered-down (sometimes referred to as “de-risking”) or have been making them more expensive. They are approaching, or in many cases have approached, a point where many financial advisors have started to no longer see a value proposition worth bringing to their clients. These insurance companies need a new solution, which the present embodiments may satisfy.

The present embodiments of the value gap process may be used as the basis from which to create new versions of these products, which may provide an effective solution to millions of Americans and investors of the world looking for retirement income security. The present embodiments may provide a value proposition that could drive significant annual sales in profitable products for the Variable Annuity industry through a large existing distribution network that is currently becoming starved for salable products to sell. Products created around the embodiments may provide a better value proposition to the end user.

Certain subsets of the broad market assets may be used to demonstrate that, since 1927 (earliest available data), there are return sources that would have allowed present embodiments to have provided significantly higher consistent average returns, thereby allowing larger draw rates without failure. These sources, or a variation thereof, could be used as underlying portfolios that would allow insurance companies to create lifetime income guarantee products at low enough costs to the clients where the insurance companies could charge enough to cover their real world costs and be profitable enough while still allowing a value gap adjusted 5% target steady withdrawal rate for the end clients and provide inflation adjustment with or without future income step-ups for the investors.

In addition to the insurance industry, the present embodiments may also be implemented for traditional non-insurance investment portfolios. Indeed, the present embodiments may be applied to any underlying return source (e.g., any investment portfolio). Thus, notwithstanding the particular benefits of applying the present embodiments to variable annuity products disclosed herein, the present embodiments should be considered broadly applicable to any investment product from which sustainable income is desired and any situation requiring the determination of an allowable income.

In addition, alternative embodiments may determine allowable income based on alternative methods of determining internal value. For example, internal value may be found through various means, beyond mathematical regression analysis. Different mathematical and other approaches may be used to determine a trend line from which to derive the value gap. For example, a trend line may be determined manually using a scatter plot. As another example, one may “eyeball” a trend line on a chart of historical price data for an investment portfolio to create an estimated internal value. The trend line used may also be nonlinear.

Example Implementation of the Present Embodiments

According to an exemplary implementation, an insurance company may create and market a deferred variable annuity specifically positioned and tasked for generating the maximum amount of reliable inflation-adjusted income for the lifetime of an individual (or married couple for an increased cost). The income may be allowed to start around a generally accepted retirement age, e.g., on or after the 62nd birthday of the individual account owner or youngest spouse if joint income is utilized. In this example, this income stream is insured to continue for the lifetime of the income beneficiary(ies) based on the claims-paying ability of the underlying insurance company.

The maximum monthly income available for the clients to withdraw after meeting the minimum age would be based on a specified target withdrawal rate. The initial monthly withdrawal amount would be calculated by multiplying the market valuation of the portfolio at that time by the target draw rate (5% in this example) and then multiplied by a value gap multiplier. This multiplier is derived from the difference between the market valuation and an estimated internal value of the underlying portfolio, for example, derived from a logarithmic regression analysis of historical data as described herein.

In this example, once started, the maximum monthly income would be adjusted for cost of living changes annually based on the actual change in trailing consumer price index data over the prior twelve months. For example, if the U.S. CPI-U had increased by 2.86% over the prior twelve months, then the income would be increased by 2.86%. If on the other hand there was a decline in CPI-U of 1.06%, then the income would be decreased accordingly. As such, the purchasing power of the client's income would effectively remain the same as long as either income beneficiary survives regardless of real world price inflation. The portfolio value from that point forward would have no bearing on the client's withdrawal amount except for the optional step-up feature described below.

Optionally, for an increased fee or even as a separate product, the client could choose to have the monthly income amount automatically recalculated in the same way as the first payment was calculated and if the result would be an increase in income, then the client would receive this permanent step-up resulting in an increase in actual purchasing power. If the calculation would result in a decrease, then the income would remain the same (other than any inflation adjustments).

In this example, since this is a specific purpose product, there are no optional or built in features that would add cost that are not in line with the lifetime income purpose. For example, the product may have no death benefit feature, and may have only one investment choice, into which the entire portfolio would be allocated. The portfolio would preferably be an all equity investment subaccount based on a portfolio for which there is significantly long historical performance data, which could be used to calculate the estimated internal value of the portfolio.

As one example, the insurance company could engage an investment firm such as Dimensional Fund Advisors (DFA)™ to construct a blended equity value style subaccount investment fund consisting of 50% Large Cap Value and 50% Small Cap Value rebalanced periodically based on the Fama-French historical portfolios described in the Morningstar U.S./Ibbotson SBBI Classic Yearbook. In this case, the investment firm would preferably use a trading platform that minimizes trade costs. Alternatively, the product could offer a different fund or multiple funds as long as an acceptable methodology exists for establishing an estimated internal value for the underlying portfolio, for example, through correlation analysis or some other means.

In this example, the product may be distributed through financial advisors. Clients may purchase the product by opening a contract either as an IRA or non-tax qualified account. Money may enter the contract in a number of possible ways. It could be deposited by check (possibly a rollover check from a retirement plan if an IRA), or by IRA transfer, or by section 1035 exchange from another variable annuity contract or insurance contract cash value. It may be purchased in one of three versions in line with present variable annuity contracts: an A-share, L-share, or C-share.

Some embodiments may provide a product specific website constructed in alignment with the insurance company's website, which may convey to a user the estimated internal value and the subsequent value gap multiplier. This multiplier may be used for determining the adjustments to all distributions for all parties. It may be based around an estimated internal value, for example, derived by conducting a logarithmic regression analysis on all available historical data—which should preferably be more than 75 years of history for the particular underlying portfolio.

The insurance company may construct the product in three traditional pricing and share classes: A, L, and C. In this particular example, the product is an L-share structure and as such has a total annual fee structure of 2.6% if single life, 2.8% if joint. This fee would cover:
Product Expenses (typically call mortality, expense and administration—M&E&A—yet without a death benefit there should really be no “M”)=140 basis points (bps).
The fund expense to the underlying investment manager (for example, DFA)=60 bps.
Cost of income insurance feature (GMWB)=40 bps single life, 60 bps joint life.
Other fees, for example, administrator fees, annual royalty, and/or licensing costs=20 bps.

Beyond the 2.6% (or 2.8% if joint), the remaining percentage of annual income (e.g., about 5% as described above in the embodiments of FIGS. 13-15) would be distributed to the account owner.

In this example, the insurance company may pay a compensation structure to the producing representatives through the affiliated broker-dealer channel of 3% when the contract is opened and a trailing compensation of an annual 1%, which starts to accrue in the 13th month and pays monthly or quarterly from that point forward.

All amounts described above in this example would be based on the value gap adjusted portfolio value and as such would be calculated independently of portfolio volatility and thus stabilize the revenue models of the insurance companies and the advisors as well as the clients. As such, in this example, these streams would be inflation adjusted going forward but would not receive a step-up (other than if the investor set up such a step-up).

As with conventional models, the insurance company may either finance or otherwise pay the up-front compensation from capital and recoup over time from the annual fee structure.

The foregoing disclosure of the embodiments has been presented for purposes of illustration and description. It is not intended to be exhaustive or to limit other embodiments to the precise forms disclosed. Many variations and modifications of the embodiments described herein will be apparent to one of ordinary skill in the art in light of the above disclosure. The scope of the embodiments is to be defined only by the claims, and by their equivalents.

Further, in describing representative embodiments of the present embodiments, the specification may have presented the method and/or process of the present embodiments as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present embodiments should not be limited to the performance of their steps in the order written, and one skilled in the art can readily appreciate that the sequences may be varied and still remain within the spirit and scope of the present embodiments.

What is claimed is:

1. A method for determining a deduction rate from a starting value, which maximizes the deduction rate without reducing the starting value to zero over a given time period, the method comprising:
using a computer processor to test deduction rates against historical data of previous changes in value of the starting value and determine a target deduction rate that achieves a desired percentage of historically successful outcomes for the starting value;
determining a value gap difference between the starting value and an estimated internal value based on historical data;
adjusting the target deduction rate by the value gap difference to determine the deduction rate,
wherein the deduction rate comprises a largest periodic amount that can be deducted from the starting value without reducing the starting value to zero over the given time period; and
sending information related to the deduction rate to a computer user interface, wherein the information is configured for use in visibly representing the deduction rate on the computer user interface.

2. The method of claim 1, further comprising adjusting the deduction rate by a subsequent value gap difference to determine an increased deduction rate, and sending the increased deduction rate to the computer user interface for display on the computer user interface.

3. The method of claim 1, wherein determining the target deduction rate comprises using a computer processor to determine a deduction rate that, based on the tests of deduction rates against the historical data, results in a minimum number of upside or downside failures when applied to the starting value when the starting value is equal to an estimated internal value.

4. The method of claim 3, wherein the minimum number is zero.

5. The method of claim 3, wherein the minimum number of upside or downside failures comprises one of 90% of outcomes with no downside failures, 100% of outcomes with no downside failures while maintaining the starting value, and 100% of outcomes with no downside failures while maintaining the starting value adjusted for inflation.

6. The method of claim 1, further comprising using the computer processor to determine the estimated internal value as a logarithmic regression of the historical data.

7. The method of claim 1, wherein adjusting the target deduction rate by the value gap difference to determine the deduction rate comprises using a computer processor to determine a proportional relationship between a total real return line associated with the starting value and a trend line associated with the starting value and to apply the proportional relationship to the target deduction rate and the starting value to determine the deduction rate.

8. The method of claim 7, wherein adjusting the target deduction rate comprises dividing the total real return line by the trend line to determine a value gap index, determining a multiplicative inverse of the value gap index to determine a value gap multiplier, and multiplying the value gap multiplier by the target deduction rate and the starting value to determine the deduction rate.

9. The method of claim 1, wherein determining the target deduction rate comprises:
conducting historical tests to determine a plurality of target deduction rates for a plurality of time horizons;
populating a target deduction rate database with the plurality of target deduction rates;
receiving a user selection of a time horizon; and
retrieving from the target deduction rate database a retrieved target deduction rate corresponding to the selected time horizon, wherein the retrieved target deduction rate is the determined target deduction rate.

10. The method of claim 1, wherein determining the target deduction rate comprises:
conducting historical tests to determine a plurality of target deduction rates for a plurality of value parameters;
populating a target draw rate database with the plurality of target deduction rates;
receiving a user selection of a value parameter; and
retrieving from the target deduction rate database a retrieved target deduction rate corresponding to the selected value parameter, wherein the retrieved target deduction rate is the determined target deduction rate.

11. The method of claim 10, wherein the plurality of value parameters comprises a desired ongoing value of assets associated with the starting value.

12. The method of claim 11, wherein the desired ongoing value is associated with a target deduction rate based on a designated percentage of historical success, wherein a historical success is a test of a deduction rate that results in no downside failure.

13. A system for determining a deduction rate from a starting value, which maximizes the deduction rate without reducing the starting value to zero over a given time period, the system comprising:
a first computer processor that determines a total real return value and an estimated internal value associated with the starting value; and
a second computer processor in communication with the first computer processor, wherein the second computer processor:
receives the total real return value and the estimated internal value from the first computer processor,
tests deduction rates against historical data of previous changes in value of the starting value and determines a target deduction rate that achieves a desired percentage of historically successful outcomes for the starting value, wherein a historically successful outcome is an outcome of the starting value not reaching zero during the given time period,
determines a value gap difference based on the total real return value and the estimated internal value,
adjusts the target deduction rate by the value gap difference to determine the deduction rate, wherein the deduction rate comprises a largest periodic amount that can be withdrawn from the starting value without reducing the starting value to zero over the given time period, and
sends information related to the deduction rate to a computer user interface, wherein the information is configured for use in visibly representing the deduction rate on the computer user interface.

14. The system of claim 13, wherein the second computer processor determines the target deduction rate based on historical tests of values of assets associated with the starting value.

15. The system of claim 13, wherein the second computer processor receives a value parameter specifying a desired ongoing value of assets associated with the starting value, and determines the target deduction rate based on the value parameter.

16. The system of claim 15, wherein the desired ongoing value is associated with a target deduction rate based on a designated percentage of historical success, wherein a historical success is a test of a deduction rate that results in no downside failure.

17. The system of claim 15, further comprising a computer graphical user interface in communication with the second computer processor, wherein the graphical user interface receives the value parameter from a user and transmits the value parameter to the second computer processor.

18. A system for optimizing decrementation of a data structure, which maximizes the decrementation without reducing a starting value of a value-fluctuating data structure to zero over a given time period, the system comprising:
a target deduction rate database including:
a first data field of time horizons, and
a second data field of target deduction rates,
wherein each target deduction rate is associated with a time horizon;
a first computer processor that calculates a total real return value and an estimated internal value associated with the starting value of the value-fluctuating data structure; and
a second computer processor in communication with the first computer processor, wherein the second computer processor:
tests deduction rates against historical data of previous changes in value of the starting value and determines, for each time horizon, a target deduction rate that achieves a desired percentage of historically successful outcomes for the starting value, wherein a historically successful outcome is an outcome of no downside failure;
populates, for each time horizon, the second data field with the determined associated target deduction rate,
receives the total real return value and the estimated internal value from the first computer processor,
receives a designation of a selected time horizon,
retrieves from the database, a selected target deduction rate associated with the selected time horizon,
determines, for the selected target deduction rate, a value gap difference based on the total real return value and the estimated internal value,
adjusts the selected target deduction rate by the value gap difference to determine a deduction rate, and
sends information related to the deduction rate to a computer user interface, wherein the information is configured for use in visibly representing the deduction rate on the computer user interface

19. The system of claim 18, wherein the target deduction rate database further includes a third data field of target deduction rates,
wherein each target deduction rate of the third data field is associated with a time horizon, and
wherein each target deduction rate of the third data field is associated with a starting value different from the second data field.

20. The system of claim 18, wherein the target deduction rate database further includes a third data field of target deduction rates,
wherein each target deduction rate of the third data field is associated with a time horizon,
wherein each target deduction rate of the third data field is associated with a desired percentage of historically successful outcomes different from the second data field,
wherein the second computer processor tests deduction rates against historical data of previous changes in value of the starting value and determines, for each time horizon, a target deduction rate of the third data field that achieves the different desired percentage of historically successful outcomes, and
wherein the second computer processor populates, for each time horizon, the third data field with the determined associated deduction rate of the third data field.
